(19) United States
(12) Patent Application Publication
(10) Pub. No.: US 2005/0275733 A1
(43) Pub. Date: Dec. 15, 2005

(54) Method and apparatus of rendering a video image by polynomial evaluation

(76) Inventor: Philip Chao, Naperville, IL (US)

Correspondence Address: Welsh & Katz, Ltd.;Jon P. Christensen, 22nd Floor, 120 South Riverside Plaza, Chicago, IL, 60606, US

(21) Appl. No.: 10/865,329

(22) Filed: Jun. 10, 2004

(51) Int. Cl. H04N 5/262; H04N 9/74

(52) U.S. Cl. 348/239; 348/578

(57) ABSTRACT

A method and apparatus are provided for rendering a video image to a destination image space from a plurality of source image spaces. The method includes the steps of generating a set of intermediate incremental values from one or more polynomials, incrementally evaluating the polynomials within a loop processing area of a source or a destination image space along an inner and an outer processing loop based upon the generated set of intermediate incremental values. During the rendering a video image, the method retrieves pixels from a source image space, creates color pattern, or blends the pixels from two source image spaces based upon the evaluated polynomials from the inner and outer loops.

### FIELD OF THE INVENTION

The field of the invention relates to video special effects and more particularly to methods of using polynomial functions to create video special effects.

### BACKGROUND OF THE INVENTION

Video special effects of changing from a source video image to an output video image are generally known. Examples that are generally known include cutting out a portion of video inside a soft-edge heart shape, adding star highlighting into the video, adding words with changing gradient color on the character faces of the word, and rotating, shearing, and resizing the words, the star highlight and the soft-edge heart shape with its video insert.

In cutting out the portion of video inside a soft-edge heart shape, the pixels of the first image located inside the heart shape is identified and copied into the output video image. Those pixels of the first image located near the edge of the heart shape are identified and colors of these pixels are modified based on the value of a polynomial function evaluated at the pixel locations. Most pixels inside the heart shape are opaque. However, in heart shape cutouts, the closer a pixel is to the edge, the higher its transparency. This gives the heart shaped cutout a soft-edge border.

In adding star highlighting to the output video image, the color of the pixels located in the area of the highlighting are mixed with white color. The mixing ratio of a particular pixel is decided based on the value of a polynomial function evaluated at the pixel location. Near the center of the highlight, the mixing ratio is very high, so, a maximum amount of white are used in the color mixing process. Near the edge of the highlight, a lower mixing ratio is used to give a slow fading of the highlight.

In adding words with gradient color on the character faces of the word to the output video image, the color of a particular pixel located inside the face of the characters of the word is decided based on the value of a polynomial function evaluated at the pixel location. The gradient color on the character faces may change as the parameters of the polynomial function changes.

After the above special effects, the video image resulting from the special effects may be further processed to add a 3D look.

While known methods of rendering video images perform adequately, they are generally computationally intensive. Some rendering techniques perform complex calculations to obtain needed high quality video images at the expense of high power processor or they completely avoid the complex calculations at the expense of providing a lesser quality image or a lesser capable special effect system. Other rendering techniques render video images slowly as a separate rendering step before outputting the video special effect. Because of the importance of video processing, a need exists for a method of rendering video image special effects that is high quality and less complex.

### OBJECTS

The main object of this invention is to provide a method and a device that has a more efficient way to calculate polynomial functions by incremental evaluation, i.e. via an addition operation only.

Another object of this invention is to provide a method and a device that has a more efficient way to calculate multiple polynomial functions each in its own bounding box. This reduces computational requirements and reduces hardware needed to evaluate many polynomial functions if the bounding boxes of these polynomials do not overlap. This is an improvement in efficiency when comparing to a device that evaluates each polynomial over the entire image, and then combine them afterwards.

Another object of this invention is to provide a method and a device that give an extra level of flexibility in adding a 3-D look to polynomial-based video special effect. This is done by modifying the polynomial function itself. This modification process changes the initialization data of a polynomial function before it's rendering begins. As a result, video special effects add a 3-D look without any extra processing during rendering, and need no additional rendering hardware for it.

Another object of this invention is to provide a method and a device that evaluate different polynomials in different regions in an image. The different regions may be separated by dividing lines. Similar to the bounding box approach, this also reduces computation requirement and reduces hardware needed to perform many video special effects. Therefore, this is also an improvement in efficiency when comparing to a device that evaluates each polynomial over the entire image, and then combine them afterwards. However, this method handles multiple regions where their bounding boxes do overlap.

Another object of this invention is to provide a more powerful and flexible device to evaluate multiple higher order polynomials. Instead of using dedicated hardware for each polynomial function, it uses one higher speed higher order polynomial engine and operates the polynomial engine sequentially to evaluate different polynomials.

Another object of this invention is to have a more efficient way to store polynomial parameters. The state memory stores the following uniformly:
Stores multiple polynomials
Stores higher order polynomials in multiple entries of the state memory
Stores self-test polynomials and their expected final states
Stores primitives for multiple frames of a video transition
Stores an extra copy of the polynomial's initial state for re-initialization later.

Another object of this invention is to provide a method and a device that has a higher system throughput in evaluating polynomial functions. The invention uses multiple polynomial engines in a pipelined arrangement.

### SUMMARY

A method and apparatus are provided for rendering a video image to a destination image space from a plurality of source image spaces. The method includes the steps of generating a set of intermediate incremental values from one or more polynomials, incrementally evaluating the polynomials within a loop processing area of a source or a destination image space along an inner and an outer processing loop based upon the generated set of intermediate incremental values. During the rendering a video image, the method retrieves pixels from a source image space, creates color pattern, or blends the pixels from two source image spaces based upon the evaluated polynomials from the inner and outer loops.

### BRIEF DESCRIPTION OF THE DRAWINGS

FIG. 1 depicts a system for rendering a video image under an illustrated embodiment of the invention.

FIG. 2A to 2D are data flow diagrams illustrating method used to incrementally evaluate two variable polynomial functions of first, second, third, and fourth-orders.

FIG. 3 lists sets of equations used to incrementally evaluate two variable polynomial functions of first, second, and third-orders by following scan line sequence.

FIG. 4 lists sets of incremental equations needed after an arbitrary incremental step for evaluating first, second, and third-orders 2-variable polynomial functions.

FIG. 5 shows a flow chart of incremental computation of polynomial function either for scan line scanning order or arbitrary parallelogram scanning order.

FIG. 6 illustrates parallelogram warping of a second-order polynomial, in this case is a hyperbola.

FIG. 7 illustrates parallelogram warping of a second-order polynomial with bounding box.

FIG. 8 shows a flow chart of incremental evaluation of polynomial functions for a bounding box based parallelogram warping video special effect.

FIG. 9 shows the steps and equations to determine the polynomial initialization data in case of bounding box based parallelogram warping.

FIG. 10 illustrates an example of Highlight by using parallelogram warping, two second-order polynomial functions (two hyperbolas).

FIG. 11 illustrates concept of mirror reflection of polynomial functions using mirror line and parallelogram warping.

FIG. 12 illustrates concept of two or more polynomial functions one on each side of arbitrary dividing line(s).

FIG. 13 illustrates incremental computation via parallelogram scanning with two polynomial functions one on each side of an arbitrary dividing line.

FIG. 14 illustrates incremental computation of distance to arbitrary dividing line and the concept of Switch Count.

FIG. 15 illustrates single-polynomial area vs. multi-polynomial area.

FIG. 16 lists equations for incremental evaluation of two second-order polynomial functions, inside multi-polynomial area one on each side of an arbitrary dividing line.

FIG. 17 shows a flow chart of incremental evaluation of polynomial functions using multi-polynomial evaluation method.

FIG. 18 illustrates an example of soft edged heart shape video effect by using parallelogram warping and multi-polynomial evaluation method for second-order polynomial functions.

FIG. 19 shows the block diagram of the polynomial processing system.

FIG. 20 shows block diagrams of the polynomial engine.

FIG. 21 shows a block diagram of the shape combination module.

FIG. 22 shows micro-operation execution sequence to perform incremental evaluation of polynomial functions across an arbitrary parallelogram scanning sequence. In addition, it shows micro-operation execution sequence to determine the direction and Switch Count for multi-polynomial evaluation method.

FIG. 23 illustrates an example of output video containing soft-edge heart shaped video, word filled with gradient color, and highlight.

FIG. 24 illustrates an example of using multiple polynomial engines in a pipelined arrangement.

### DETAILED DESCRIPTION OF AN ILLUSTRATED EMBODIMENT

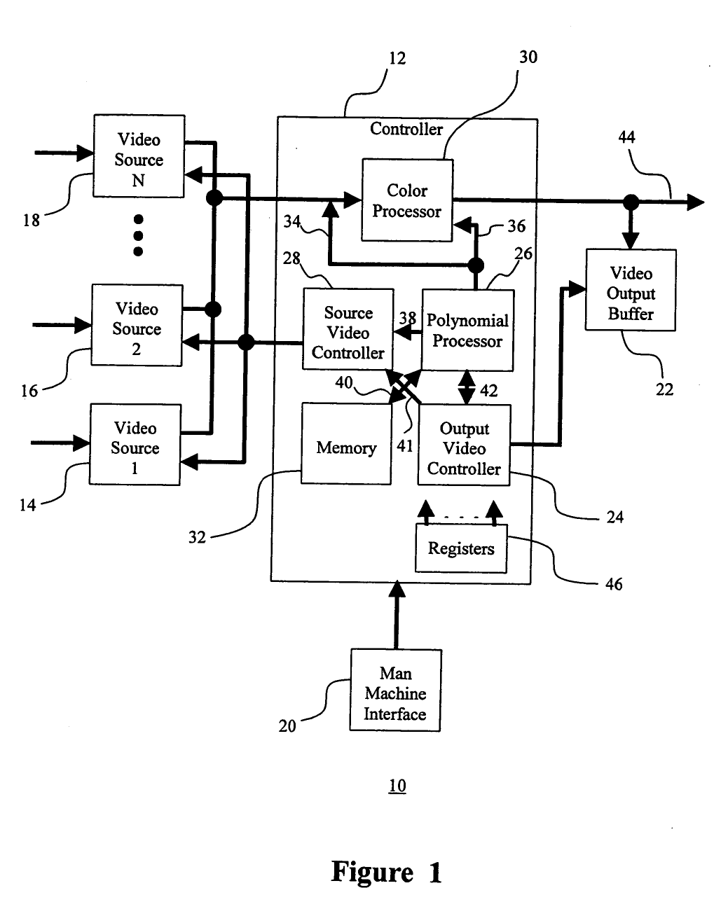

FIG. 1 is a video rendering system 10 shown generally in accordance with an illustrated embodiment of the invention. Under the illustrated embodiment, the Controller 12 functions to identify and render source pixels into an output video 44 from any of a number of video sources 14, 16, 18. Output video may be displayed on TV monitor, or may be stored in the Video Output Buffer, 22, to be used later.

Selection of the type of special effect to be rendered may be accomplished through a man-machine interface (MMI) (e.g., a keyboard and monitor) 20.

In order to render an image, an operator (not shown) may select a video special effect from a list of available effects. Once selected, the video special effect defines several two-variable polynomial functions over the 2-dimensional image space with one variable being the column position, let's call it X, and another variable being the row position of a pixel, call it Y. Each polynomial function has a value for each pixel on the image. One way to visualize a polynomial function is to picture them as a family of curves (or lines), one polynomial value per curve, and the family of curves forms a surface across the x-y plane. The evaluation of the polynomial functions is performed by polynomial processor, 26.

The video special effect also defines relationships between the polynomial functions and attributes of the output video. The attributes of the output video includes, but not limited to, texture mapping information, background color information, and color processing information (together referred to as special effect controlling information). These special effect controlling information are copied to registers, 46, and a memory, 32, inside the controller, 12. In addition, this information is sent to the polynomial processor, 26, on a timely basis.

“Texture mapping information” specifies how the polynomial functions relate pixel coordinates between video source and video output. Texture mapping function is performed by the Source Video Controller, 28. “Background color information” specifies how to generate background video source information, such as gradient color by polynomial functions. The background color generation function is performed via a Color Processor color input, 34. “Color processing information” specifies how to generate output video color from multiple source video controlled by polynomial functions (e.g. blending colors from two source video). Color processing function is controlled via a Color Processor control input, 36.

In one example, four second-order polynomial functions and four first-order polynomial functions can be combined to create a rotated soft edged heart shape. In this example, the polynomial functions divide the output video image space into three distinct areas, in which the first area, inside the heart shape, is for video from a first video source, and the second area, outside of the heart shape, is for video from the second video source, and the third area, near the edge of the heart shape, is for video from both video sources. In the first area, the polynomial functions define texture mapping information even if the heart shape is rotated. In the third area, the polynomial functions also define the blending ratio used to combine the two video sources to produce the output video image.

In another example, two second-order polynomial functions can be combined to create a spot highlight effect. In this example, the larger value of the two polynomial functions is used to control the blending with the white color. The higher the value of the polynomial function, the more white is added to the color of a source pixel. The lower the value of the polynomial function, the less white is added to the color of a source pixel.

In another example, one second-order polynomial function can be used to create a radial shape color gradient as the background video source for the output video.

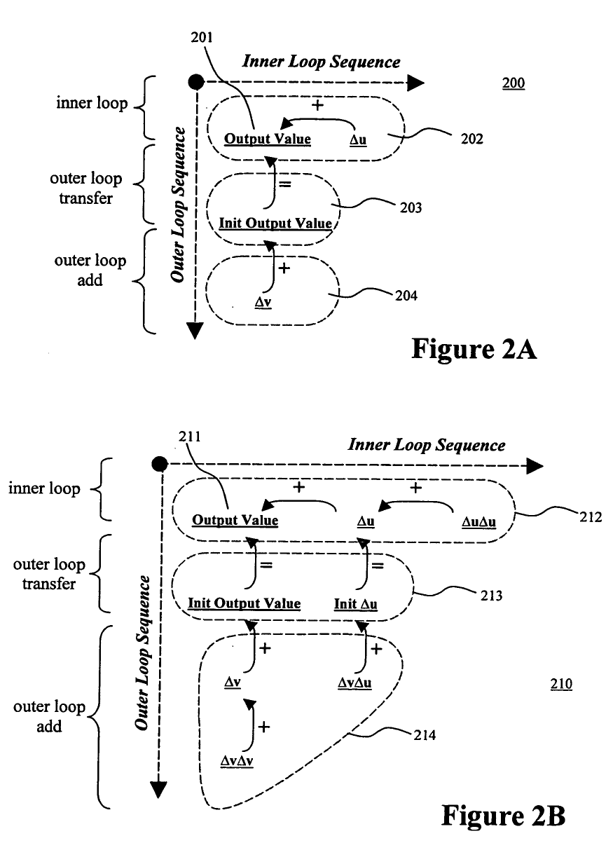

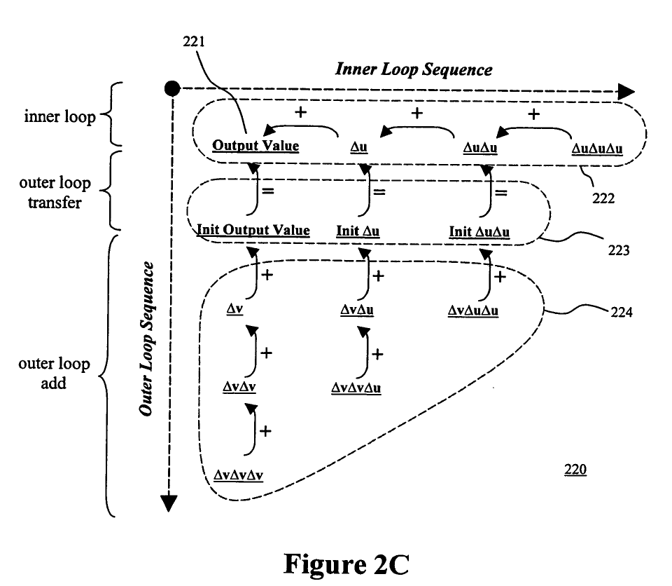

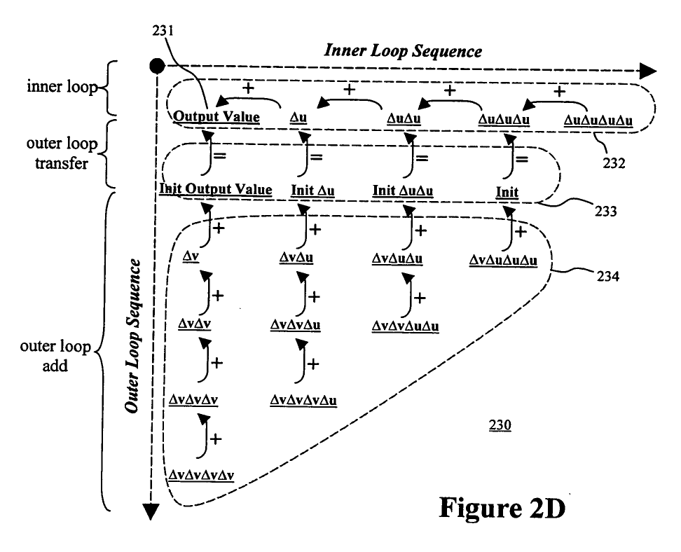

FIG. 2A to 2D are data flow diagrams for illustrating a method, which incrementally evaluates two variable polynomial functions of first, second, third, and fourth-orders over a 2-dimensional array of sample points. The area covered by the 2-dimensional array of sample points is called loop processing area. One of the two dimensions is called outer loop, and the other, inner loop of the loop processing area. As used herein, incremental evaluation means adding an incremental value to a previous value or a starting value where the incremental value may be any whole or fractional number.

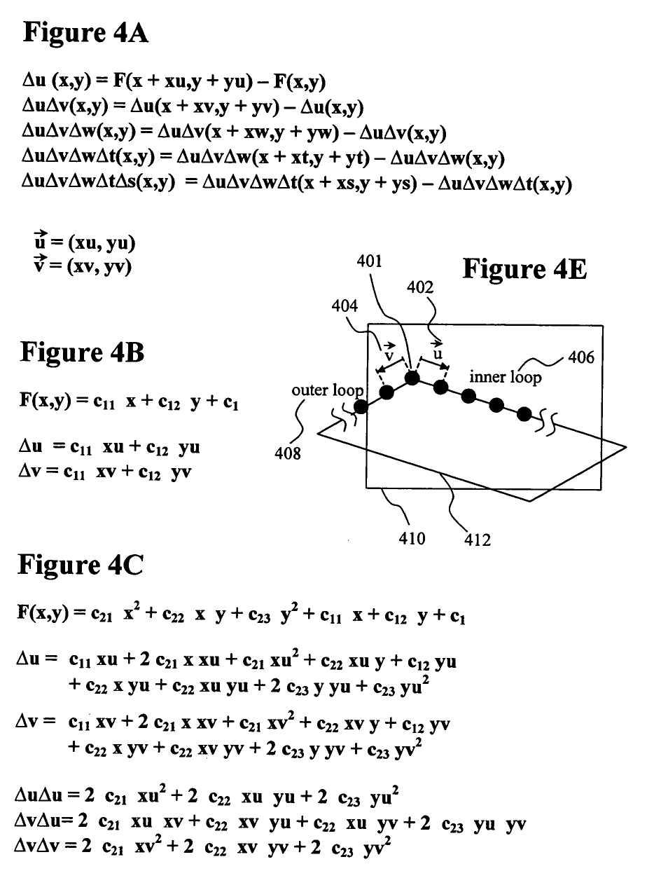

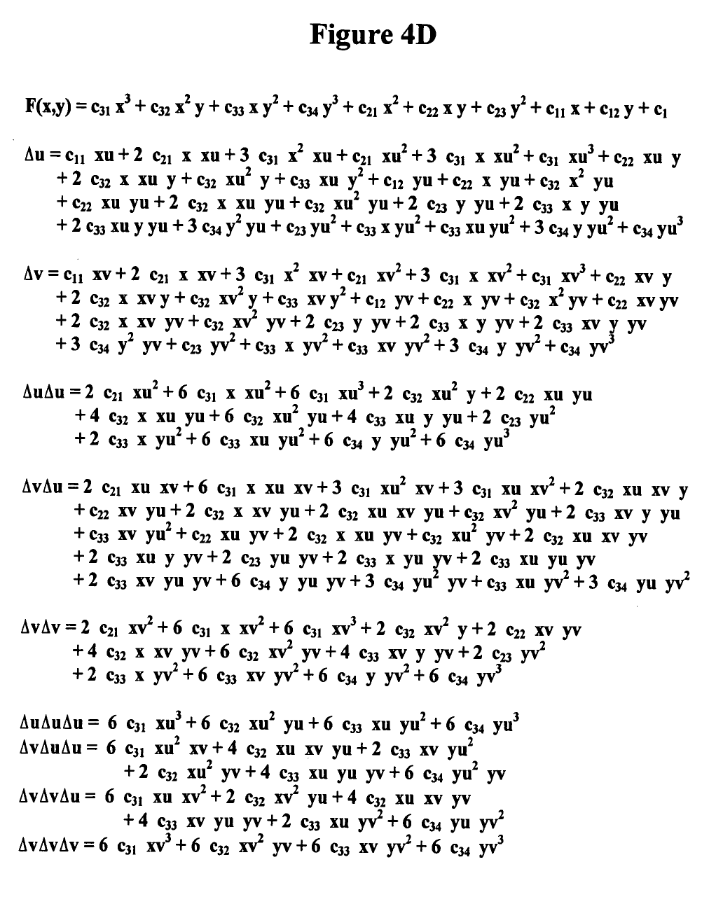

FIG. 4E shows that a polynomial function is evaluated over a parallelogram shape loop processing area. It consists of outer loop, 408, and inner loop, 406. Every sample point in this loop processing area has a polynomial value evaluated incrementally according to the value at the previous sample point and several intermediate values. Output values of evaluated polynomial functions are available at 201, 211, 221, 231. Three types of intermediate values are: inner loop intermediate values, outer loop intermediate values, and inner loop starting values.

Inner loop intermediate values are Δu, ΔuΔu, ΔuΔuΔu etc, and are referenced by numbers 202, 212, 222, 232 for first, second, third, and fourth order polynomial functions in FIG. 2. Outer loop intermediate values are Δv, ΔvΔv, ΔvΔvΔv, ΔvΔu, ΔvΔvΔu, ΔvΔuΔu, etc, and are referenced by 204, 214, 224, 234 for first, second, third, and fourth orders polynomial functions. Inner loop starting values are needed by the inner loop computation as the starting values at the beginning of each next line. They are “init output value”, “init Δu”, “init ΔuΔu”, “init ΔuΔuΔu” etc., and are 203, 213, 223, 233 for first, second, third, and fourth order polynomial functions.

An arrow from A to B with a “+” sign indicates an incremental value A is added to an intermediate value B. The value B keeps the sum. An arrow from A to B with a “=” sign indicates value A is copied to value B.

At the beginning of the parallelogram shape loop processing sequence, 401 in FIG. 4E, all intermediate values are initialized with the polynomial function's initialization data. Each outer loop iteration incrementally computes all outer loop intermediate values and inner loop starting values. This is illustrated by many “+” arrows inside 204, 214, 224, 234. Lets call them “outer loop add operation”. At the beginning of an inner loop, inner loop starting values are used to initialize inner loop intermediate values. This is illustrated by many “=” arrows from 203, 213, 223, 233 to 202, 212, 222, 232. Lets call them “outer loop transfer operation”. Each inner loop iteration incrementally computes all inner loop intermediate values for the next sample point. This is illustrated by many “+” arrows inside 202, 212, 222, 232. Lets call them “inner loop operation”.

All intermediate values form a triangle shape data flow diagram. As the order of the polynomial function increases, the number of intermediate value increases, and the size of the triangle shaped data flow diagram increases. The arrangement of each intermediate value in the diagram is the same. Higher order polynomial functions can be evaluated by extending the inner loop, outer loop add, and outer loop transfer operations in their triangle shaped data flow diagrams.

Inner loop operations are performed at every output pixel. Outer loop operations are performed before the beginning of every output scan line. To perform polynomial evaluation at the video frame rate, the inner loop needs to be processed frequently and fast. The outer loop computation does not have the same constrain, and is performed during the time between the end of one scan line and the beginning of the next scan line of the output video.

Some intermediate values are constant values, and some intermediate values are incrementally computed from other intermediate values. For example, for third-order, ΔΔΔ intermediate values are all constant, ΔΔ intermediate values are first-order polynomial functions, and Δ intermediate values are second-order polynomial functions.

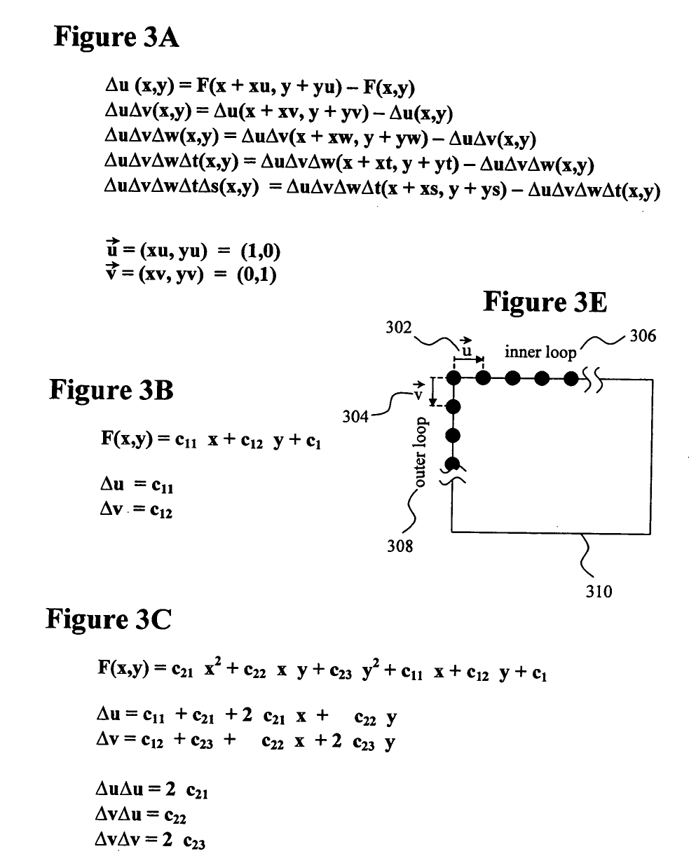

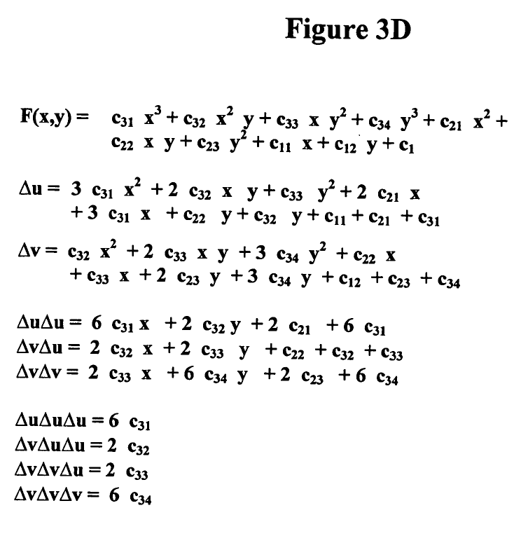

If a loop processing area in the source video is identical to the rectangle output video as shown in FIG. 3E, then, FIG. 3B, 3C, 3D provide equations for computing the polynomial's initialization data for first, second, and third-order polynomial functions. Lets say that this loop processing follows a “scan line scanning order”.

FIG. 3A shows the mathematical definitions of these intermediate values. Scan line scanning order means that a sample point's (X, Y) coordinate changes by (+1, 0) for each inner loop iteration and changes by (0, +1) for each outer loop iteration. For example, FIG. 3D shows how to compute initial values of Δu, Δv, ΔuΔu, ΔvΔu, ΔvΔv, ΔuΔuΔu, ΔvΔuΔu, ΔvΔvΔu, and ΔvΔvΔv needed in FIG. 2C for a third-order polynomial.

If a loop processing area in the source video is a parallelogram shape as shown in FIG. 4E, then FIGS. 4B, 4C, 4D provide the equations for computing the polynomial's initialization data for first, second, and third-order polynomial functions. Lets say that this loop processing follows an “arbitrary parallelogram shape scanning order”.

FIG. 4A shows the definition of difference equations, and is the same as FIG. 3A. For an arbitrary parallelogram scanning order, the inner loop sample point coordinates change by (xᵤ,yᵤ), or by a u vector, and the outer loop sample point coordinates change by (xᵥ,yᵥ), or by a v vector. The equations in FIGS. 4B, 4C, and 4D are more complex than the equations in FIGS. 3B, 3C, and 3D because the coordinate changes are simpler in FIG. 3. For any third-order two variable polynomial function, and any arbitrary parallelogram scanning order, all intermediate values used for initialization can be computed according to FIG. 4D. Higher order polynomials can also be derived the same way, except the equations are longer.

These equations are used to compute the initialization values before the rendering. In addition, initialization values only need to be computed once for each output video image.

For video special effect applications, output pixels produced for the output video are always in line order, which means one horizontal scan line at a time. For every output pixel in the output video, there is a corresponding sample point in the parallelogram shaped loop processing area in the source video. As the output video finishes one scan line, the parallelogram loop processing area finishes one inner loop. When the output video finishes the last line of the video frame, the parallelogram loop processing area finishes the last inner loop. In this way, every output pixel has a polynomial value evaluated at the coordinate of the corresponding sample point in the parallelogram loop processing area inside the source video.

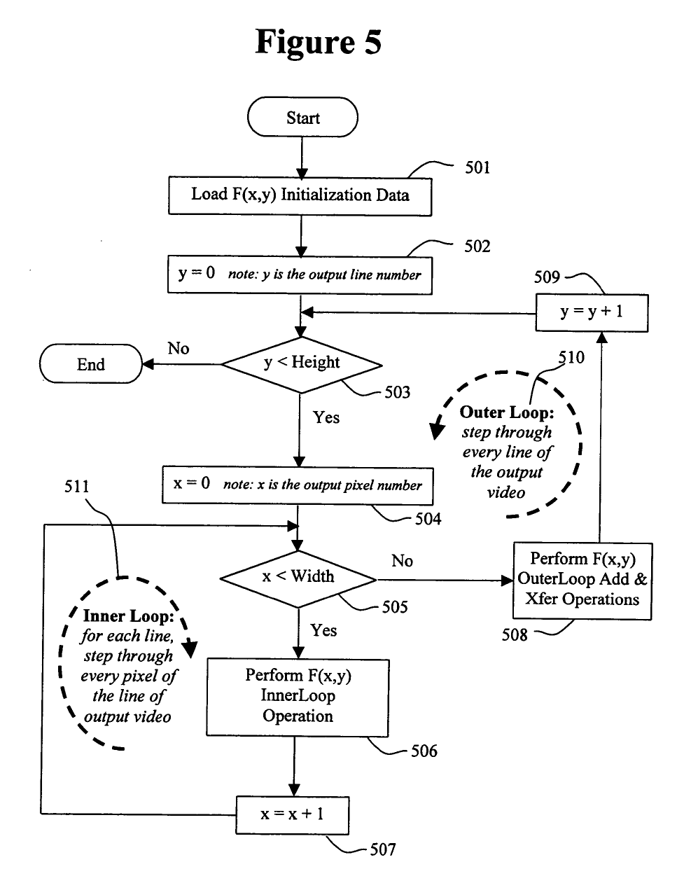

FIG. 5 shows a flow chart of incremental computation of polynomial functions either for the scan line scanning order or an arbitrary parallelogram scanning order. X and Y are the coordinates of the output pixel. Width and Height in 505 and 503 are the dimensions of an output video. The initialization data in 501 are evaluated according to the equations in FIG. 3 if it is a scan line scanning order or FIG. 4 if it is a parallelogram scanning order. Inner loop 511 repeats 505, 506, 507 for all inner loop iterations from X=0 until X=Width−1. Outer loop 510 repeats 503, 504, 505, 508, 509 for all iterations from Y=0 until Y=Height−1.

Most video special effects use several polynomial functions to control rendering attributes including texture mapping. The incremental evaluations for all polynomial functions are performed synchronously throughout the inner loops and outer loop. Source video may be scanned by parallelogram shaped scanning sequences consisting of outer loop and inner loops, as illustrated in FIG. 4E, for generating video special effects.

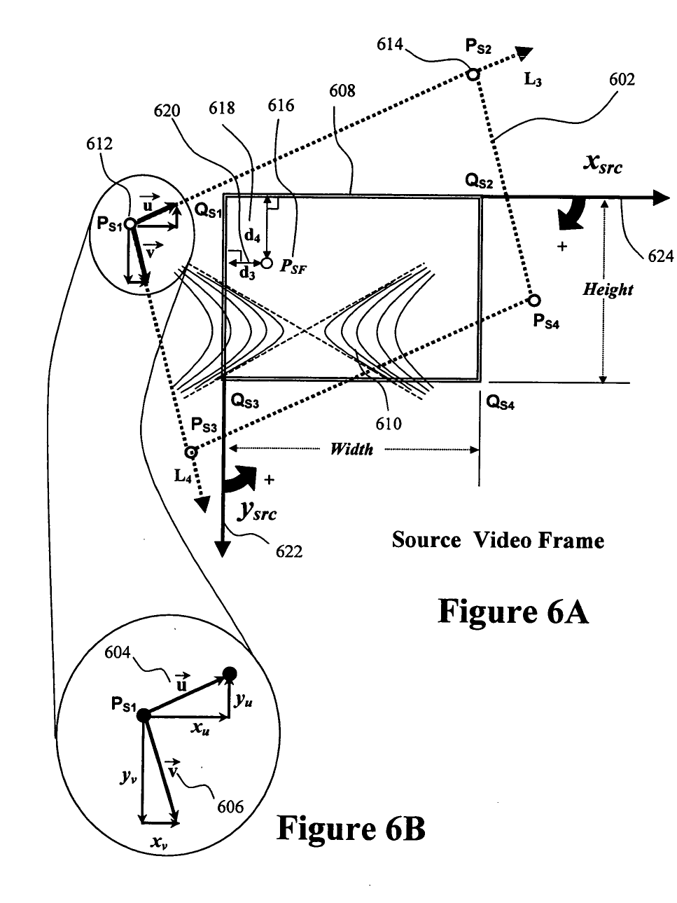

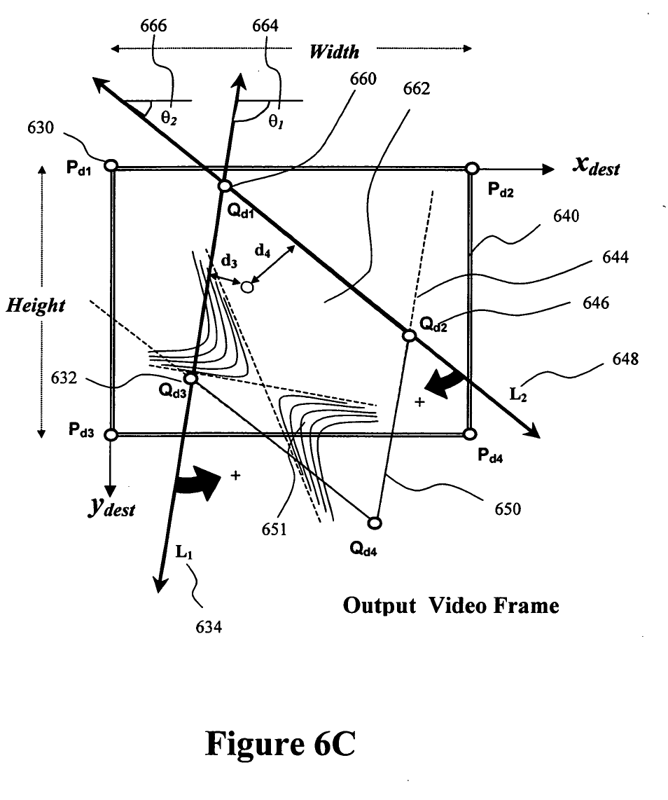

In one type of video special effect as illustrated in FIG. 6, the polynomial function F, 610, covering the entire source video, 608 in FIG. 6A is distorted to a new polynomial function G, 651, fit inside a user defined parallelogram area, 650 in FIG. 6C, of the output video, 640.

As a result, the values of polynomial F at the four edges of the source video, Qₐ₁, Qₛ₂, Qₛ₄, Qₛ₃, 608 in FIG. 6A, match the values of polynomial G at the four edges of the user defined parallelogram Q_{d1}, Q_{d2}, Q_{d4}, Q_{d3}, 650 in the output video, 640 in FIG. 6C. Also, the values of Polynomial G at the four edges of the output P_{d1}, P_{d2}, P_{d4}, P_{d3}, 640, match the values of polynomial F at the four edges of a parallelogram shape loop processing area Pₛ₁, Pₛ₂, Pₛ₄, Pₛ₃, 602. Let's call this parallelogram shape loop processing area the “virtual parallelogram” area because this parallelogram is for the source video and not visible in the output video. Let's also call this shape changing technique the “parallelogram warping” of a polynomial function.

There is a one-to-one relationship between inner loops inside the virtual parallelogram area and scan lines inside the output video. And the values of polynomial function F across an inner loop of the virtual parallelogram are used as the values of polynomial function G across a scan line of the output video.

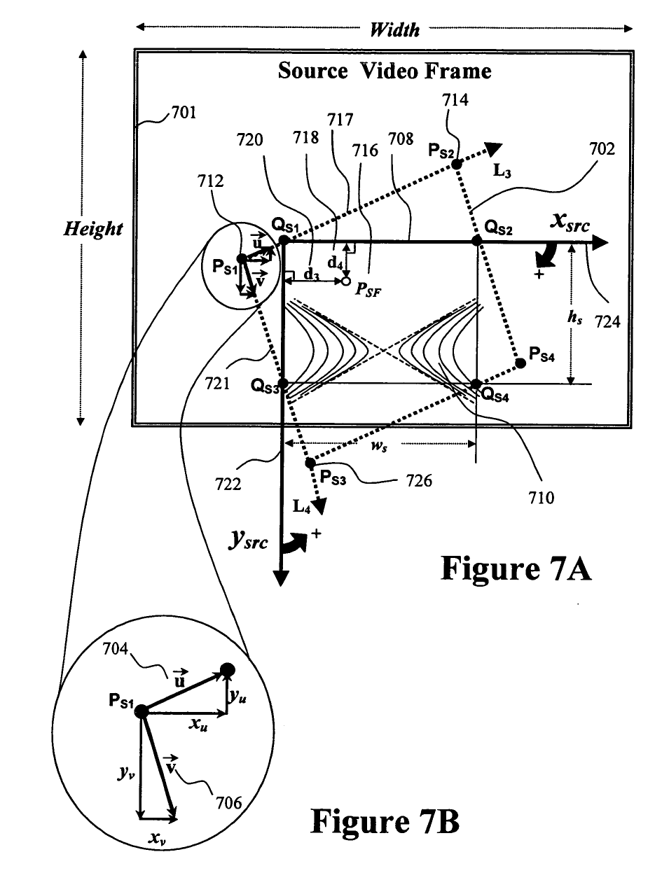

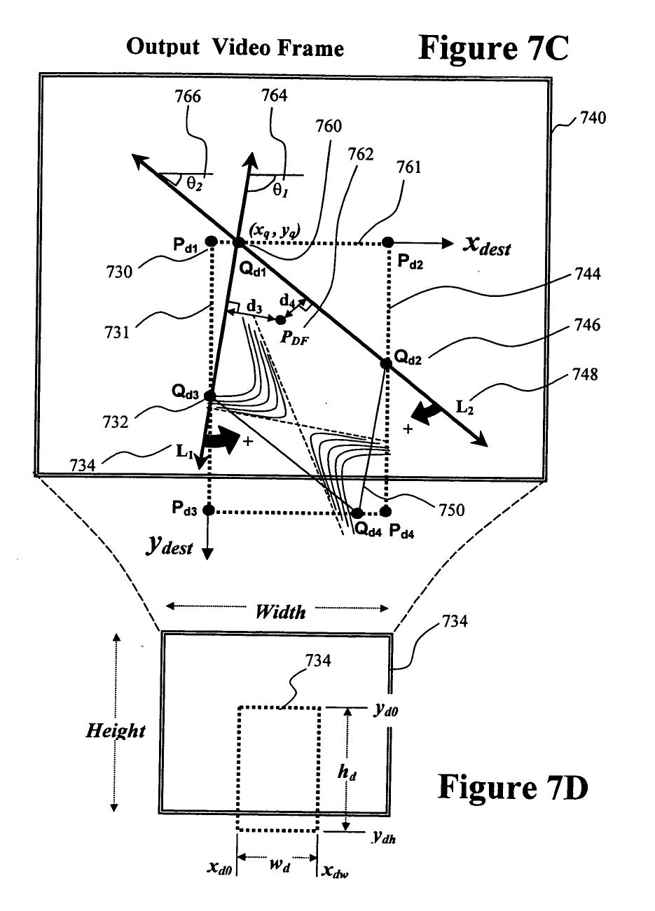

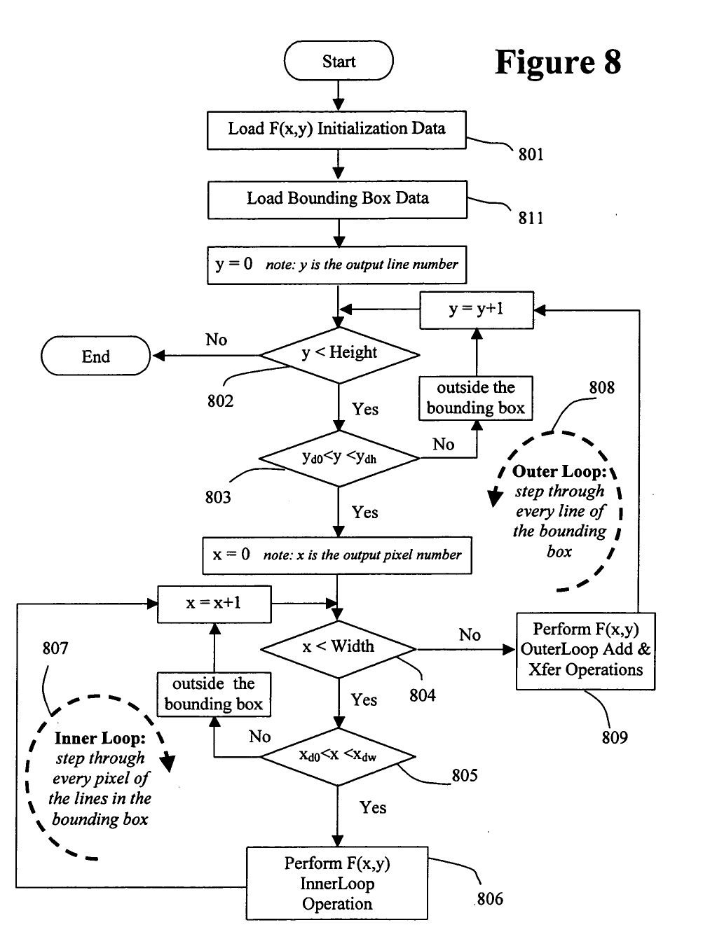

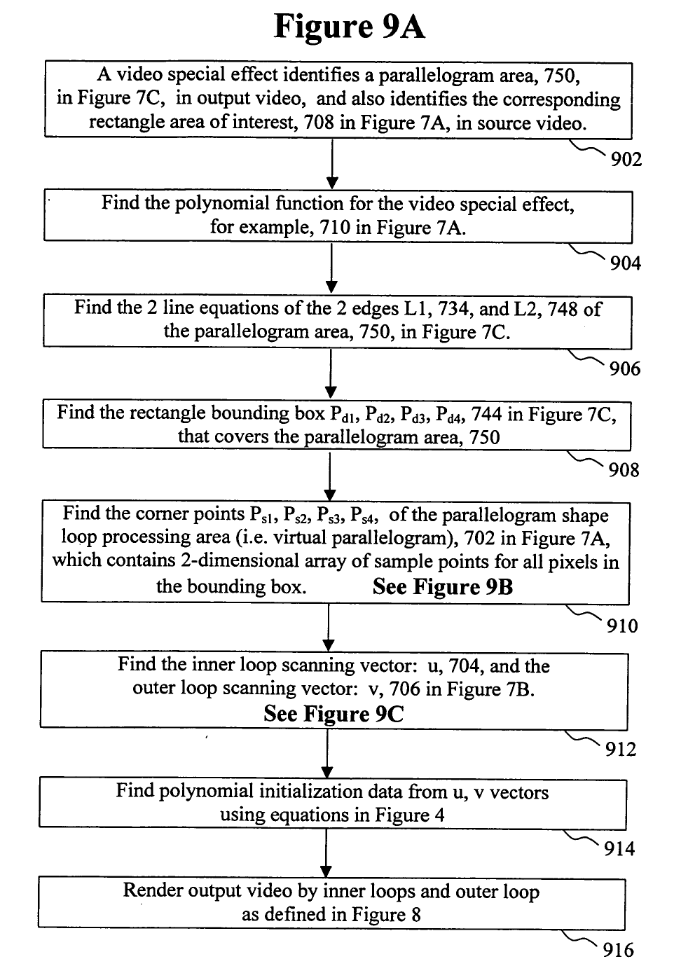

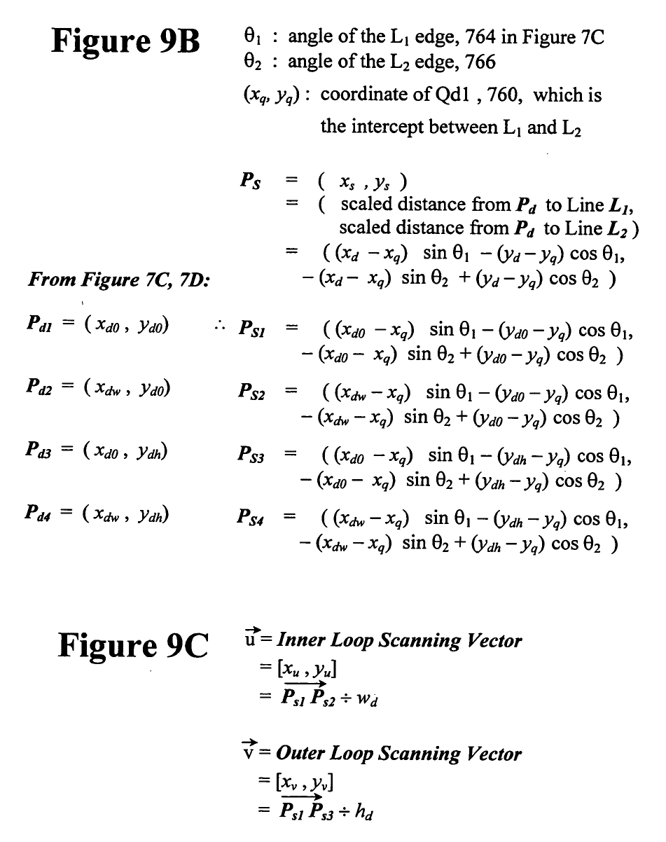

FIG. 7 illustrates the concept of bounding box-based parallelogram warping of a polynomial function, in this case, the polynomial function is illustrated by a family of second-order hyperbola curves. An upright hyperbola function, 710, covering all pixels of a particular rectangular area of interest Qₛ₁, Qₛ₂, Qₛ₃, Qₛ₄, 708 (FIG. 7A), inside the source video, 701, is warped into a parallelogram Q_{d1}, Q_{d2}, Q_{d3}, Q_{d4}, 750 (FIG. 7C), in the output video, 740. There is a rectangle “bounding box” P_{d1}, P_{d2}, P_{d3}, P_{d4}, 744, covering all the pixels of this parallelogram 750 in the output video, 740.

The parallelogram shape loop processing area (i.e. virtual parallelogram area) for the bounding box is Pₛ₁, Pₛ₂, Pₛ₄, Pₛ₃, 702, in FIG. 7A. It also has a one-to-one relationship between inner loops inside this virtual parallelogram and scan lines inside the bounding box of the output video.

Due to this one-to-one relationship, the four corners of the virtual parallelogram correspond to the four corners of the bounding box. The four edges of the virtual parallelogram correspond to the four edges of the bounding box.

The edge, 717, of the virtual parallelogram which corresponds to the top edge of the bounding box is the “inner loop” of the Loop Processing Area. Every pixel on the top edge of the bounding box in the output video has a corresponding sample point in the inner loop in the source video. The edge, 721, of the virtual parallelogram which corresponds to the left edge of the rectangle bounding box is the “outer loop” of the Loop Processing Area. Every scan line passing through the bounding box has a corresponding sample point in the outer loop. Each sample point in this outer loop is the starting point of an inner loop.

In FIG. 7A, direction from Pₛ₁, 712, to Pₛ₂, 714, is the inner loop scanning direction. It corresponds to the scan line order of the output video. The direction from Pₛ₁, 712, to Pₛ₃, 726, is the outer loop scanning direction, and this corresponds to the vertical direction of the output video. In the inner loop, as the evaluated output pixel moves toward right in the X direction by 1 in the output video 740, sampling points in the virtual parallelogram 702 move incrementally by the u vector 704 in FIG. 7B. In the outer loop, as the output pixel location moves down in the Y direction by 1 in the output video, sampling points in the virtual parallelogram 702 move incrementally by the v vector 706 in FIG. 7B.

As the output video is rendered across its screen area, 740, the output video's pixel coordinate must be used to determine if this pixel is inside the bounding box 744. If the output pixel is outside the bounding box 744, the polynomial is not evaluated. Otherwise, the polynomial is evaluated.

FIG. 8 shows a flow chart of rendering video special effect while incrementally evaluating a polynomial function F(x,y) according to the bounding box based parallelogram warping method. This flow chart is similar to FIG. 5. Boxes 801 and 811 indicate initialization of polynomial calculations including the bounding box data. The testing of the current output pixel coordinate against the edges of the bounding box is done at step 803 for outer loops, and at step 805 for inner loops. All inner loop operations are performed inside the bounding box. After inner loop operations, the outer loop operation is postponed to the end of the scan line, by test 804. If a scan line is completely outside of the bounding box, then no outer loop and no inner loop operation is performed. This is done by test 803. This way, the polynomial processor may be shared among different polynomial functions as long as these bounding boxes do not overlap.

The parallelogram warping method allows all polynomial function-based video special effects to be warped into parallelogram shape in the output video space. For example, the heart shape briefly described earlier is created using four second-order polynomial functions. By applying parallelogram warping, it can be animated as a flying heart shape that may flip and turn, just as a piece of paper cut into a heart shape, if a user were to release it and let it fly in the wind.

FIG. 9 shows the steps and equations to determine the initialization data of a polynomial function. This initialization data is required at the beginning of a video special effect using bounding box parallelogram warping technique.

In the first step, 902, user selects a video special effect. The selected video special effect identifies two areas of interest: a parallelogram area, 750, in FIG. 7C, in output video and another rectangular area, 708 in FIG. 7A, in source video. Next, 904, determines the polynomial functions for the video special effect, for example, 710 in FIG. 7A.

In FIG. 7C, from Q_{d1}, Q_{d2}, Q_{d3}, Q_{d4}, we can find the two line equations of the two edges of the parallelogram: Line L1, Q_{d1} Q_{d3}, or 734, and Line L2, Q_{d1} Q_{d2}, or 748. Lets call (x_{q}, y_{q}) the coordinate of Q_{d1}, 760. Line angles of the two lines L1 and L2 are θ₁, 764, and θ₂, 766. This step is shown as 906 in FIG. 9A.

From Q_{d1}, Q_{d2}, Q_{d3}, Q_{d4}, we also can find the rectangle bounding box P_{d1}, P_{d2}, P_{d3}, P_{d4}, 744, that covers the parallelogram area, 750. The is done by taking the minimum and maximum of the x coordinates of the 4 points Q_{d1}, Q_{d2}, Q_{d3}, Q_{d4} and the minimum and maximum of the y coordinates of the 4 points Q_{d1}, Q_{d2}, Q_{d3}, Q_{d4}. This step is 908 in FIG. 9A.

The next step, 910, is to find the corner points Pₛ₁, Pₛ₂, Pₛ₃, Pₛ₄, of the parallelogram shape loop processing area (i.e. virtual parallelogram), 702 in FIG. 7A, which contains 2-dimensional array of sample points for all pixels in the bounding box, 744.

This step requires to define mathematic formula for a texture mapping between the two areas identified in the first step. One way to create a texture mapping between any rectangle area and a parallelogram area is using distances. This is illustrated in FIG. 7A. Point PSF, 716 inside the rectangle 708 is mapped to P_{DF}, 762 inside the parallelogram 750 in FIG. 7C if P_{SF} and P_{DF} meet the following condition: d3, P_{DF}'s distance to line L₁, 734, is equal to P_{SF}'s distance to Y_{src} axis, 722, and, d4, P_{DF}'s distance to line L₂, 748, is equal to P_{SF}'S distance to X_{src} axis, 724. Such mapping guarantees the corresponding edges map to each other, and the mapping is linear across the area.

FIG. 9B shows the detail equations to compute the Pₛ₁, Pₛ₂, Pₛ₃, Pₛ₄ from P_{d1}, P_{d2}, P_{d3}, P_{d4} using this “distance method”. The determinations of distance may occur within a distance processing application operating within the polynomial processor.

From each of the four corner points of the bounding box P_{d1}, P_{d2}, P_{d3}, P_{d4}, we compute the two distances to the two lines L₁, L₂, by using “distance between point and line” formula. The signed distance, d, between a point at (x,y) and a line pass through (Xq, Yq) with angle θ is
d=(X−Xq)sin θ−(Y−Yq)cos θ
One side of the line will have positive distance, and the other side, negative distance. If reversed sign is desired, then,
d=−(X−Xq)sin θ+(Y−Yq)cos θ.
Source coordinates of Ps1, Ps2, Ps3 and Ps4 are calculated based on these distance equations as listed in FIG. 9B.

The resulting 4 points form another parallelogram Pₛ₁, Pₛ₂, Pₛ₃, Pₛ₄, 702.

In the next step, 912, we can compute the inner loop scanning vector: u, 704, and the outer loop scanning vector: v, 706, from Pₛ₁, Pₛ₂, Pₛ₃, Pₛ₄. The equations for u and v are listed in FIG. 9C where wd and hd are the width and the height of the bounding box, see FIG. 7D. Next, 914, We can compute polynomial initialization data from the u, v vectors using the formula in FIG. 4.

In adding star highlighting to the output video image, the color of the pixels located in the area of the highlight are mixed with white color. The mixing ratio of a particular pixel is decided based on the value of a polynomial function evaluated at the pixel location. Near the center of the highlight, the mixing ratio is very high, so, maximum amount of white are used in the color mixing process. Near the edge of the highlight, a lower mixing ratio is used to give a slow fading of the highlight.

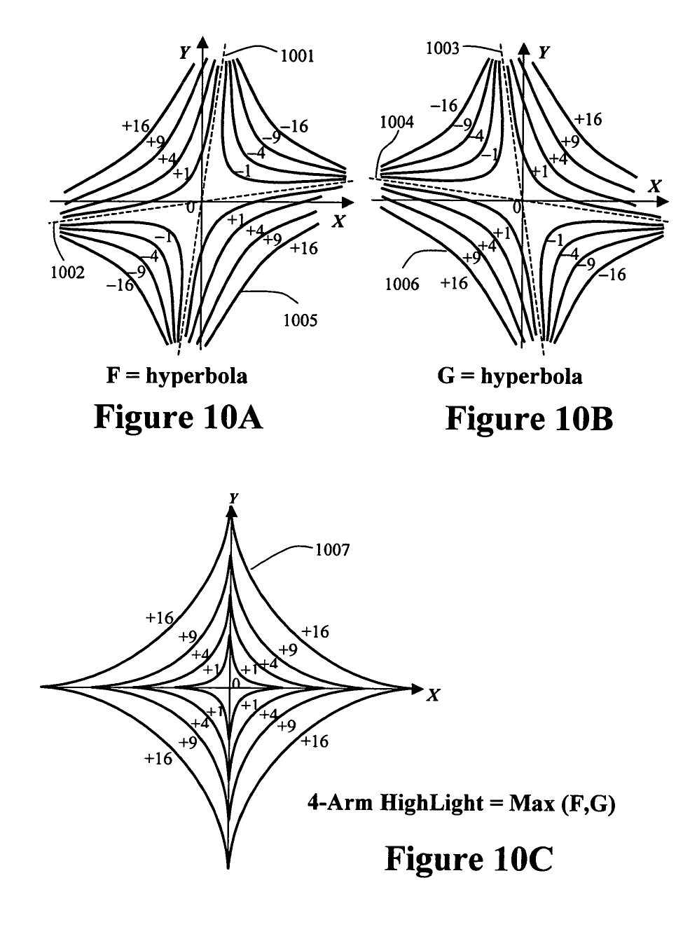

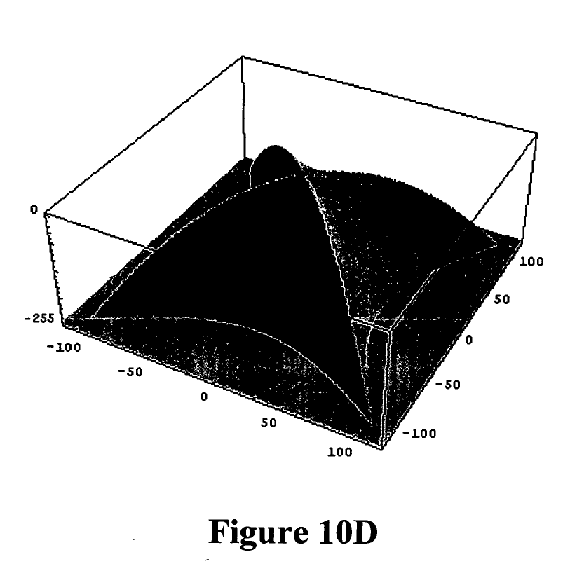

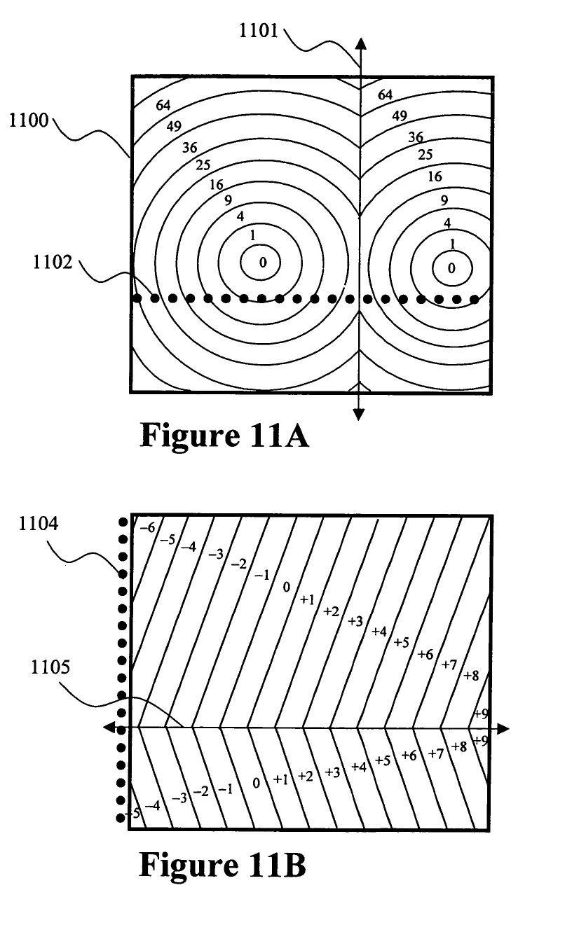

FIG. 10 illustrates a way to create such highlight in the output video by using parallelogram warping on two second-order polynomial functions (i.e. hyperbolas). The value of the polynomial is used as the blending ratio of the output video with white color. To simulate a four-arm star highlight, polynomial value of zero means the brightest color, or complete white. Any polynomial value larger than positive 255 means no highlight. Since zero value is always at the asymptote lines, 1001, 1002, 1003, 1004, of any hyperbola, such highlight does not look real. FIG. 10 illustrates an improved four-arm highlight 1007 by taking the maximum of two hyperbolas 1005, 1006. The process of taking the maximum value provided by one of the 2 hyperbolas 1005, 1006 may be referred to as using a non-additive combination of the two polynomials.

The result 1007 is produced without parallelogram warping. If we apply parallelogram warping to the hyperbola 1005, 1006 the four-arm highlight 1007 can be rotated, sheared, and resized. Such result may be obtained by simply changing the initialization value of the polynomial function and requires no extra processing during rendering of the output video. FIG. 10D illustrates the combined polynomial surface of 1007.

When we compute a polynomial function for every pixel of a full screen video frame, incremental polynomial evaluation hardware may be used for the entire video frame. If polynomial functions A and B need to be evaluated for different and non-overlapping portions of the screen area, it is more efficient to use the same incremental polynomial evaluation hardware to evaluate them in their own screen area. Lets call this method of sharing polynomial evaluation hardware for non-overlapping screen areas the “multi-polynomial evaluation method”.

Many video special effects have different polynomial functions covering different screen areas, and their screen areas do not overlap. The bounding box-based approach illustrated in FIG. 7 and FIG. 8 computes different polynomial functions inside different bounding boxes and allows sharing of the polynomial evaluation hardware if the bounding boxes do not overlap in the output video frame.

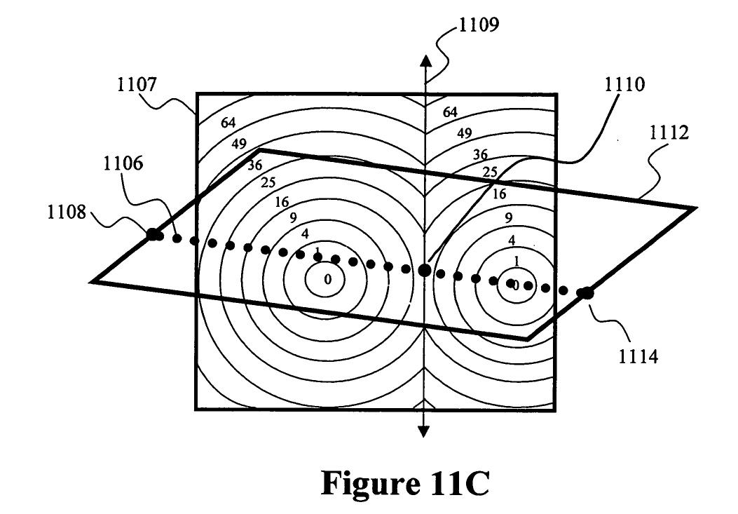

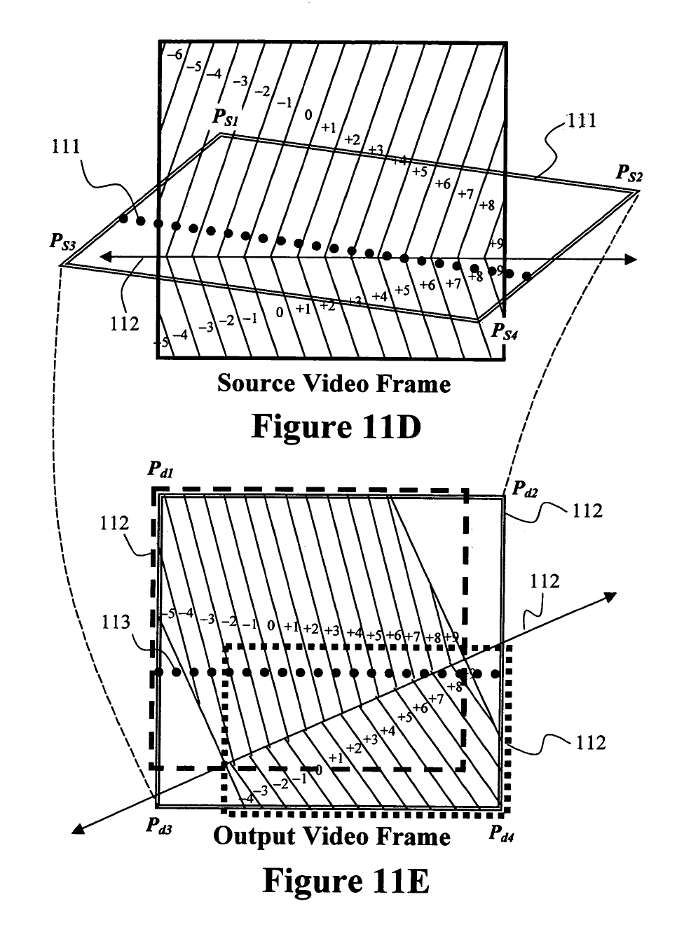

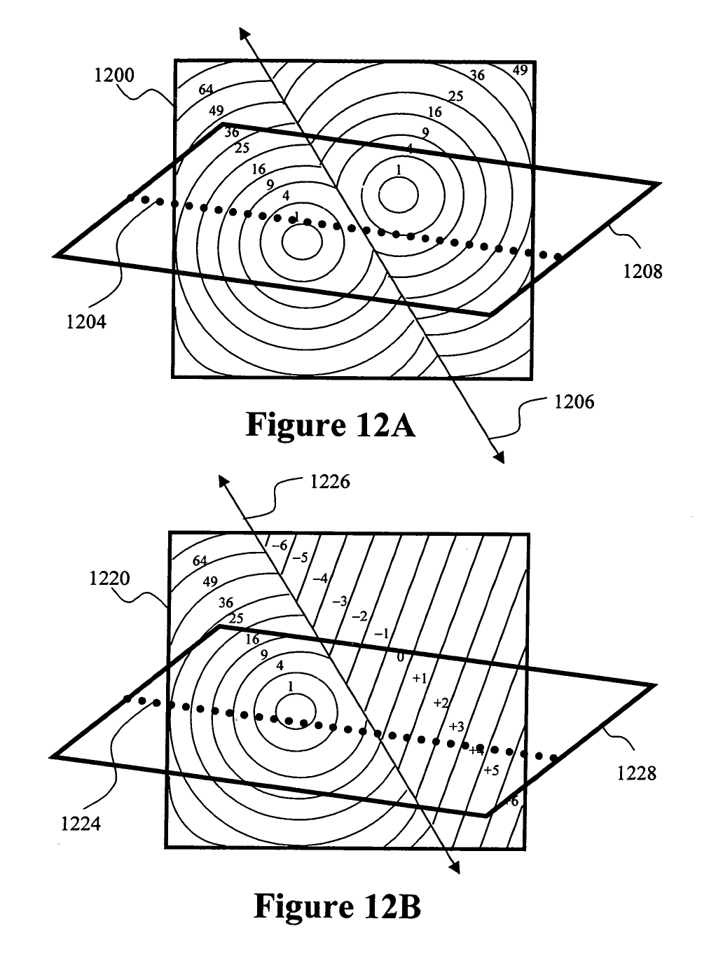

FIG. 11A and 11B illustrates a frequent situation. If a video special effect is symmetrical across horizontal mirror line illustrated in FIG. 11A, the polynomial function on the left side of the mirror line is different from the polynomial function on the right side and they are mirror reflection of each other. In the case of the scan line scanning order, an incremental inner loop computation along the scan line, 1102, may change to a decremental inner loop computation once past the mirror line to produce the second polynomial.

If a video special effect is symmetrical across the vertical mirror line illustrated in FIG. 11B, the polynomial function on the top side of the mirror line is different from the polynomial function on the bottom side and they are mirror reflections of each other. In the case of the scan line scanning order, an incremental outer loop computation, 1104, may change to a decremental outer loop computation once past the mirror line. In this way, the same polynomial evaluation hardware can process two symmetrical polynomials in the output video for situations illustrated in FIGS. 11A and 11B.

However, in case of an arbitrary parallelogram scanning order, this increment-decrement technique will not work, as illustrated in FIG. 11C. In FIG. 11C, parallelogram warping is applied to the polynomial functions in FIG. 11A. Parallelogram 1112 represents the loop processing area. The figure shows the particular inner loop, 1106, travels across different polynomial values at two sides of the mirror line, 1109. The first part of the inner loop, 1106, between 1108 and 1110 decreases to 1, then, increases. The second part of the inner loop between 1110 and 1114 decreases to 0, then, increases. These two parts of the same inner loop are not mirror reflection to each other. Therefore, the increment-decrement technique will not work.

In FIG. 11D, parallelogram warping is applied to the polynomial functions in FIG. 11B. Parallelogram 1118 represents the loop processing area. The figure shows the particular inner loop, 1116, travels across different polynomial values at two sides of the mirror line, 1120. Its corresponding output scan line is 1130 in FIG. 11E. Mirror line, 1124 in the output video, 1128, in Figure 11E corresponds to mirror line, 1120, in source video in FIG. 11D. The two bounding boxes, 1122 and 1126, in the output video, cover the two polynomial areas at the two sides of the mirror line, 1124. However, these two bounding boxes do overlap. Therefore, the bounding box technique of sharing polynomial evaluation hardware will not work here.

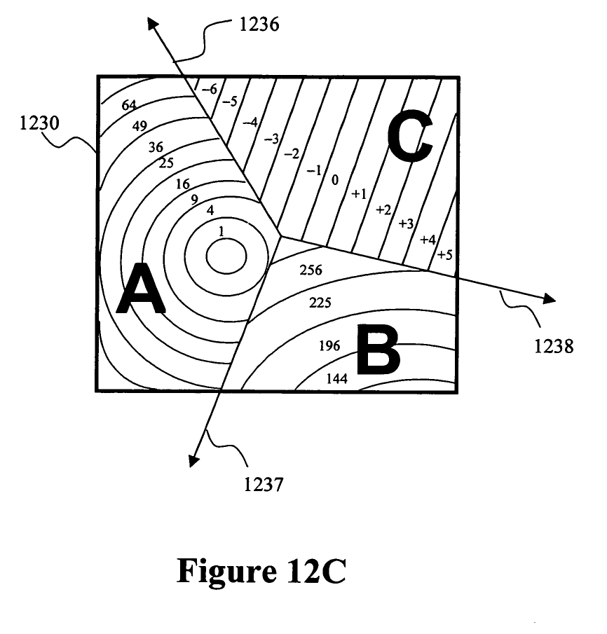

FIG. 12A shows that two polynomials evaluated at opposing sides of an arbitrary mirror line that are mirror images of each other. FIG. 12B illustrates two different polynomial functions one on each side of an arbitrary dividing line. They are not mirror reflection of each other. FIG. 12C show three different polynomial functions occupying three different areas of the output video. These areas are separated by three dividing lines 1236, 1237 and 1238.

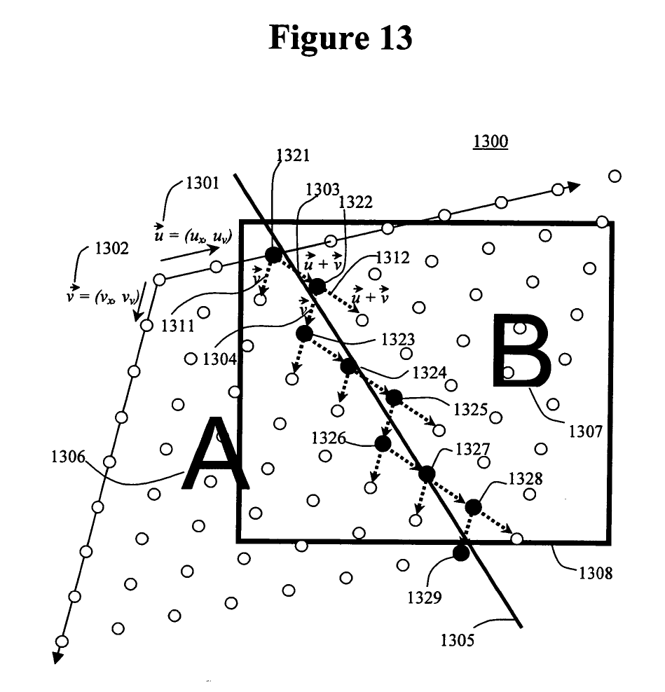

FIG. 13 to 17 illustrates the “multi-polynomial evaluation method” for sharing polynomial evaluation hardware among several polynomials, such as examples illustrated in FIGS. 12A and 12B, when applicable areas of the polynomials do not overlap and the bounding boxes of these applicable areas do overlap. The method is not limited to two polynomial areas, it can be extended to handle multiple polynomial areas similar to FIG. 12C.

Under the illustrated embodiment of the invention, FIG. 13 shows two polynomial functions that may share the same single polynomial evaluation hardware. The source video screen areas corresponding to the two polynomials are separated by a line, 1305. Let's assume the inner loops are from left to right following the u vector and the outer loop is from top to bottom following the v vector. Let's call A, 1306, the polynomial function, on the left side of the dividing line, and B, 1307, the polynomial function on the right side of the dividing line.

For every inner loop, there is a sample point called a “switch point”. A switch point defined by the first sample point evaluates polynomial B, so it is the start of inner loop for polynomial B. For each inner loop, all sample points on the left side of the switch point evaluate polynomial A, all sample points on the right side of the switch point evaluate polynomial B.

Inner loop operations of polynomial function A starts to evaluate at the beginning of the inner loop, and follows the algorithm in FIG. 2 and FIG. 5. Inner loop operation of polynomial function B also follows algorithm in FIG. 2 and FIG. 5 because the inner loop intermediate values are computed based on coordination change along the inner loop direction, (Xᵤ, Yᵤ) or u vector, 1301. This vector is the same for both polynomial A and polynomial B.

However, their outer loop calculations are different. Outer loop operation of polynomial function A follows the algorithm in FIG. 2 and FIG. 5. According to FIG. 2 and FIG. 5, the outer loop intermediate values are computed based on coordinate change along the outer loop direction, (Xᵥ, Yᵥ) or v vector, 1302. For the example in FIG. 13, since the inner loops of polynomial function B starts at switch points 1321 to 1329, its outer loop operation must compute the polynomial's intermediate values at these switch points. For inner loop starting 1322, its outer loop calculation may be based on previous inner loop starting point 1321. The coordinate change from sample point 1321 to sample point 1322 is (Xu+Xv, Yu+Yv), i.e. vector u+v, 1303. For inner loop starting 1323, its outer loop calculation may be based on previous inner loop starting point 1322 and the coordinate change from sample point 1322 to sample point 1323 is (Xv, Yv), i.e. vector v, 1304.

In general, when the outer loop of polynomial B follows an arbitrary dividing line, 1305, two alternative updates of outer loops exist depending on which one of the two alternative is closer to the line 1305. Let's call the two alternative coordinate changes of the inner loop starting point the v₁ vector and the v₂ vector. The v₁ vector and v₂ vector are the sum of a single v vector and integer multiples of the u vector. The integer multiples of the u vector for v₁ and v₂ are always different by one. Before an outer loop operation, one must decide which coordinate change to use during the outer loop operation.

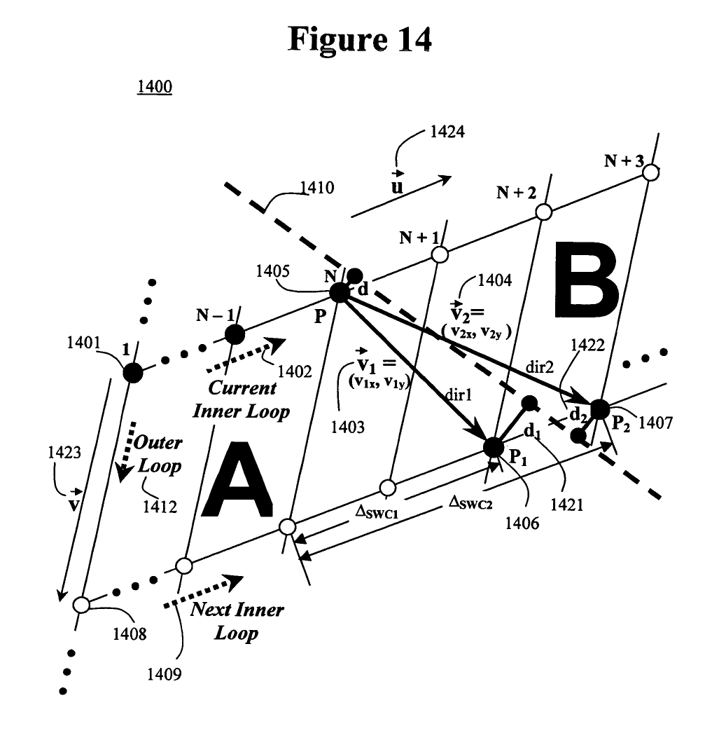

FIG. 14 illustrates a way to make such a decision. The decision is made by an incremental computation of the distance between the dividing line 1410 and the switch point P, 1405.

Let's call Switch Count the sequence number of the switch point within the particular inner loop. FIG. 14 shows the current inner loop, 1402, has the Switch Count equal to N. Vector u, 1424, represents the coordinate change between inner loop sample points. Vector v, 1423, represents the coordinate change between outer loop iterations for polynomial A.

For the next inner loop, 1409, the switch point can be one of the two alternative points P₁, 1406, or P₂, 1407. Vector v₁, 1403, represents the coordinate change between two switch points P and P₁. Vector V₂, 1404, represents the coordinate change between two switch points P and P₂.

In this example,
v₁=v+2u
v₂=v+3u

Lets refer to the two alternative coordinate changes of the switch points as direction dir1 and direction dir2 respectively. The Switch Count of the sample point P₁ is the sum of the current Switch Count N and ΔSWC1. The Switch Count of sample point P₂ is the sum of the current Switch Count N and ΔSWC2. The decision of which switch point to use depends on the distance, d₁, 1421, between the sample point P₁ and the dividing line, and the distance, d₂, 1422, between sample point P₂ to the dividing line. The switch point closer to the dividing line (i.e. having the smaller distance) is the next switch point.

The computation of d₁ and d₂ for the next switch point of the next inner loop is done incrementally from the current switch point of the current inner loop. Δd₁ and Δd₂ are the incremental values for d₁ and d₂ respectively.

If P₁ is closer to the dividing line 1410, outer loop intermediate values associated with vector V₁ should be used for outer loop operation. Otherwise, outer loop intermediate value associate with vector V₂ should be used.

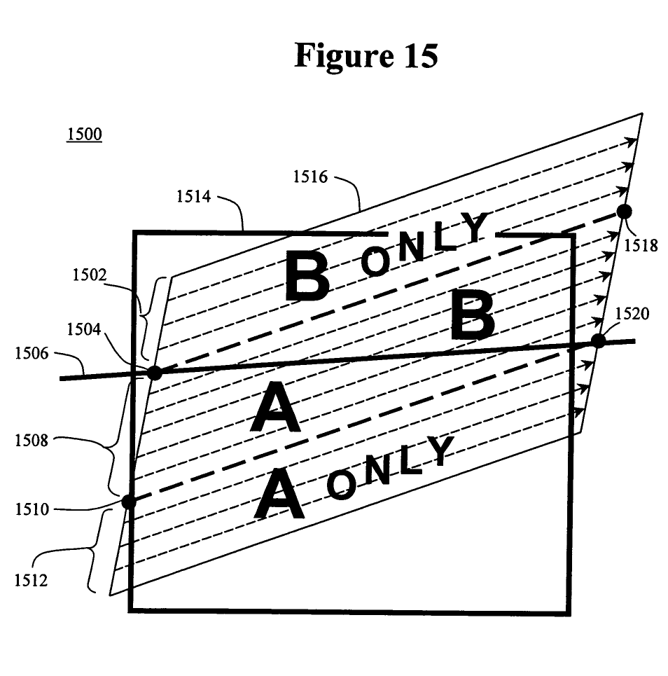

FIG. 15 illustrates a dividing line, 1506 dividing the parallelogram scanning area, 1516, to two. The upper area, 1502, only evaluates polynomial function B, while the lower area, 1512, only evaluates polynomial function A. For these two areas, polynomial functions are evaluated as previously described in FIG. 2 and FIG. 5. Lets call these inner loops in “single polynomial area” 1502 and 1512. The dividing line enters the parallelogram scanning area at point 1504, and exits the area at point 1520.

Inner loops between 1504 and 1510 evaluates polynomial A for all samples from the start of the inner loop up to the dividing line, and evaluates polynomial B for the rest of the inner loop. Let's call these inner loops the “multi-polynomial area”, 1508.

Computing both A and B requires a u vector and a v vector for polynomial A and the same u vector and three v vectors for polynomial B. The three v vectors are v, v₁, 1403, v₂, 1404, and each has their own outer loop intermediate value computation.

For polynomial B inside the “multi-polynomial area”, all outer loops need to determine the distances between the two alternative switch points to the dividing line. Furthermore, due to the two alternative outer loop vectors, additional intermediate values are computed based on additional constant values.

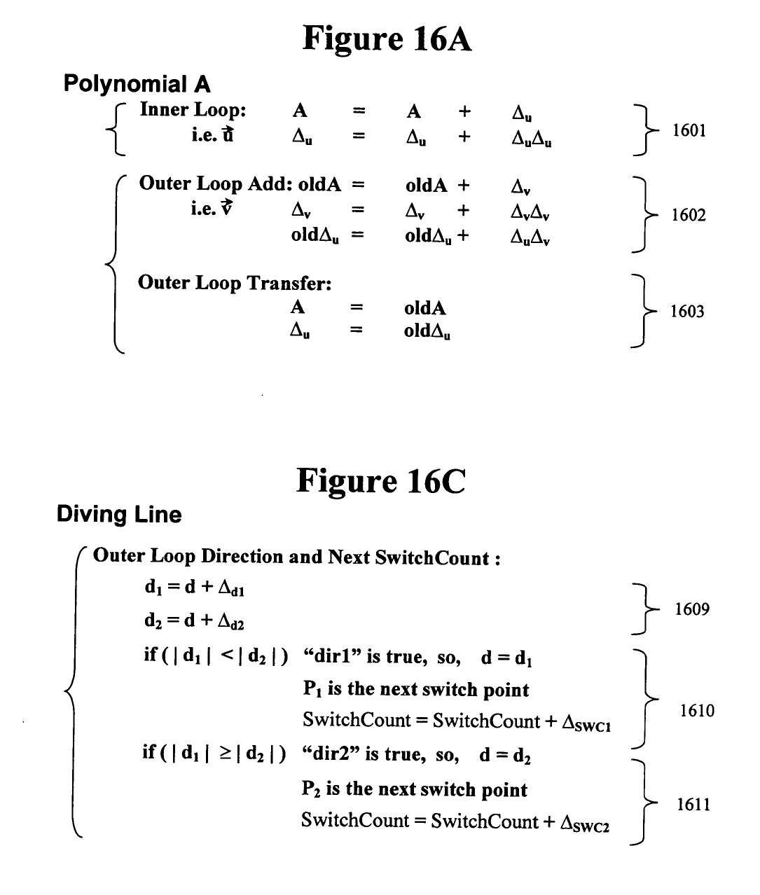

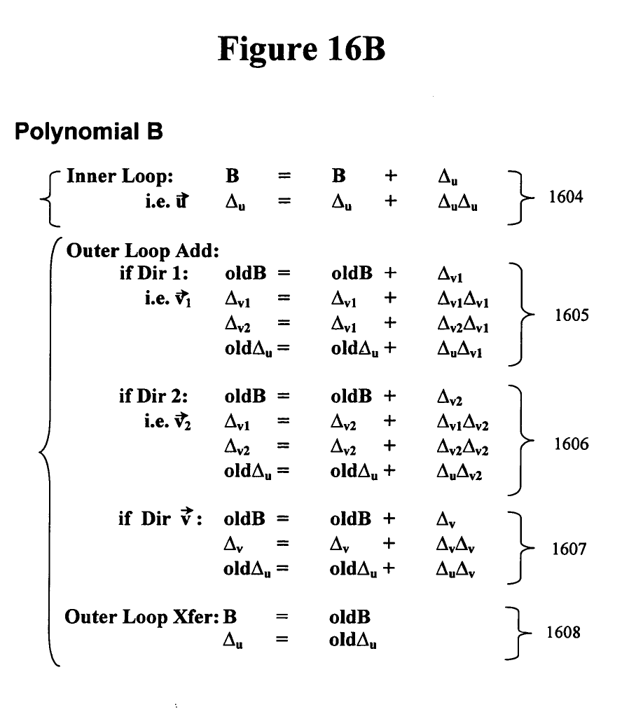

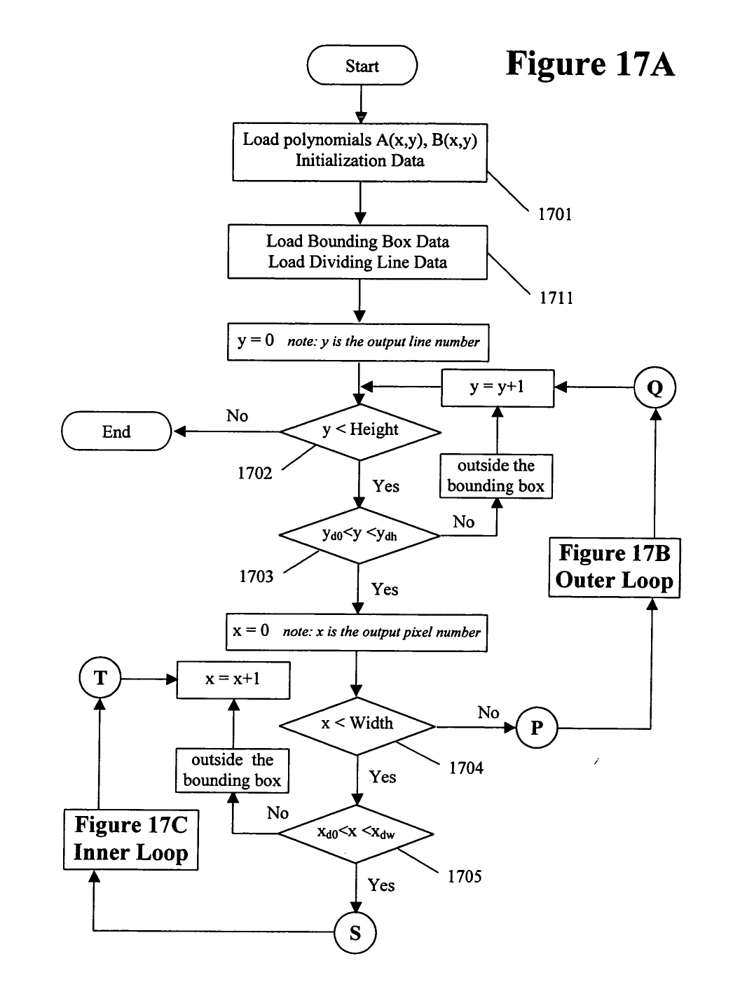

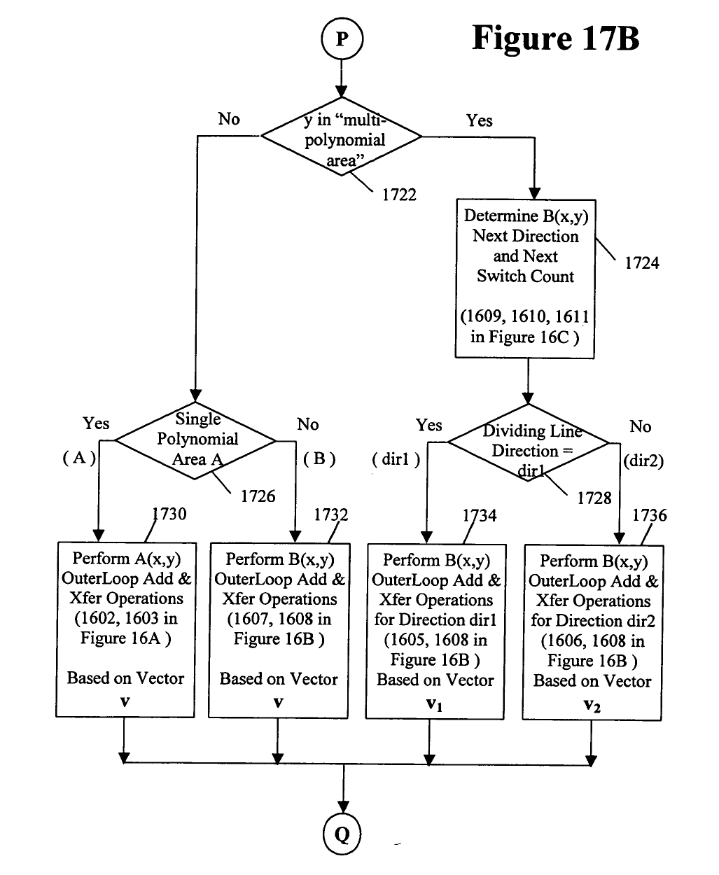

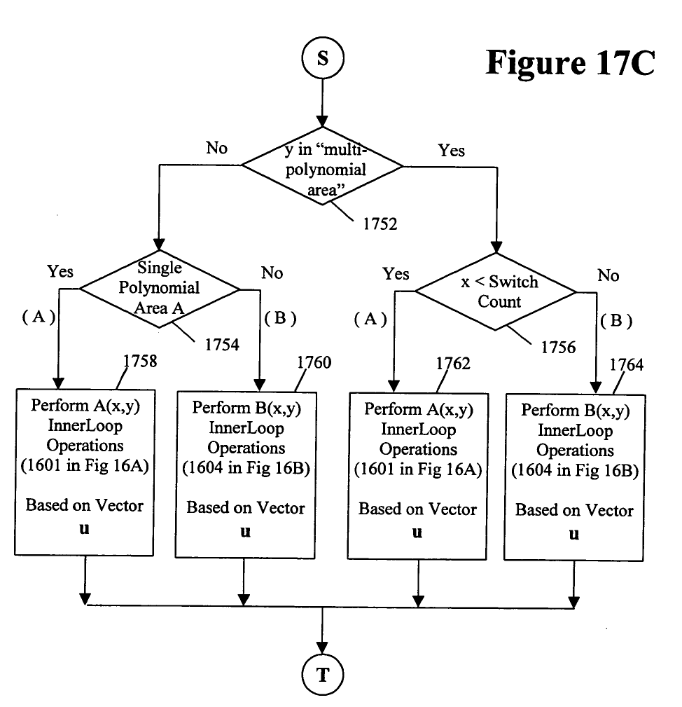

FIG. 16 lists incremental equations needed to perform two different second-order polynomial functions using an arbitrary dividing line to separate the applicable areas on the video screen.

For polynomial function A, its evaluation in FIG. 16A follows the incremental computations described in FIG. 2B. Its inner loop is computed by step 1601 based on inner loop vector u, the “outer loop add” is computed by step 1602 based on the outer loop vector v, and the inner loop starting values are initialized by outer loop transfer, 1603.

For polynomial function B outside the “multi-polynomial area”, its evaluation in FIG. 16B also follows incremental computations described in FIG. 2B. Its inner loop is computed by step 1604 based on the inner loop vector u, and the “outer loop add” is computed by step 1607 based on the outer loop vector v, and the inner loop starting values are initialized by the outer loop transfer, 1608.

To evaluate polynomial B inside the “multi-polynomial area”, its inner loop is computed by 1604 based on the inner loop vector u. Due to the two alternative outer loop vectors v₁, v₂ inside the “multi-polynomial area”, it is necessary to compute additional outer loop intermediate values. If the next switch point follows direction dir1, its “outer loop add” is computed by 1605 based on outer loop vector v₁. In this case, two Δv are computed: Δᵥ₁ and Δᵥ₂, are incremented by “Δᵥ₁Δᵥ₂” and “Δᵥ₂Δᵥ₂” respectively. In addition, OldΔᵤ is incremented by “ΔᵤΔᵥ₁”.

If the next switch point follows direction dir2, its “outer loop add” is computed by 1606 based on outer loop vector v₂. In this case, two Δᵥ are also computed: Δᵥ₁ and Δᵥ₂, are incremented by “Δᵥ₁Δᵥ₂” and “Δᵥ₂Δᵥ₂” respectively. OldΔᵤ is incremented by “ΔᵤΔᵥ₂”. “Δᵥ₁Δᵥ₁”, “Δᵥ₂Δᵥ₁”, “Δᵥ₁Δᵥ₂”, “Δᵥ₂Δᵥ₂”, “ΔᵤΔᵥ₁”, and “ΔᵤΔᵥ₂” are additional constant values needed for polynomial B inside the “multi-polynomial area”. The inner loop starting values are initialized by outer loop transfer, 1608.

The incremental computation used to determine outer loop direction is illustrated in 1609 in FIG. 16C. It computes the distances from the two potential next switch points to the dividing line. Tests 1610 and 1611 compares the two distances and picks the direction with a closer switch point. It updates the Switch Count value accordingly.

To meet the output video frame rate, all inner loop operations, 1601, 1604, are performed very rapidly using the algorithm in FIG. 2. Although outer loop operations are longer, such as 1605 or 1606, these outer loop operations can be performed sequentially during the non-rendering time between two scan lines.

FIG. 17 shows a flow chart for rendering video special effect while incrementally evaluating polynomial functions using the “multi-polynomial evaluation method”.

In FIG. 17A, similar to flow chart in FIG. 8, but two polynomial functions A(x,y) and B(x,y) are evaluated. 1701 and 1711 performs initialization for both polynomial functions including the bounding box data and dividing line data.

FIG. 17B and FIG. 17C are the flow charts for the outer loop and inner loop operations respectively. The testing of the current output pixel coordinate against the edges of the bounding box is done by 1703 for outer loop, and 1705 for inner loop.

In FIG. 17C, 1752 tests if the current inner loop is in the “multi-polynomial area”. If it is not, then, it is in the “single-polynomial area”, and either polynomial A or B is evaluated for the entire inner loop, 1758 or 1760. The method illustrated by FIG. 8 is used. If test 1752 is true, both polynomial A and B are evaluated for different parts of the inner loop. The method illustrated by FIG. 14 may be used. In this case, the x coordinate of the output pixel is compared against the Switch Count, 1756, to find out if the output pixel is currently within the part of the inner loop for polynomial A, or polynomial B. If it is in the polynomial A portion, 1762, then polynomial A performs the inner loop operation as illustrated in 1601 in FIG. 16. If it is in the polynomial B portion, 1764, then polynomial B performs inner loop operation as illustrated in 1604.

In FIG. 17B, 1722 tests if the current inner loop is in the “multi-polynomial area”. If it is not, either polynomial A or B is evaluated for the outer loop. The method illustrated in FIG. 8 is used. In the case of polynomial A, its outer loop operations, 1730, is listed in 1602 and 1603 in FIG. 16. In case of polynomial B, its outer loop operations, 1732, is listed in 1607 and 1608.

If test 1722 is true, polynomial A and B are both evaluated for different parts of the inner loop. The method illustrated in FIG. 14 is used. In this case, dividing line information is used to determine if polynomial B's next direction is dir 1, or dir 2. It also determines the next Switch Count in 1724. Their operations are listed in 1609, 1610, and 1611.

If the direction of the dividing line is closer to dir1, polynomial B performs outer loop operations 1734, and it is listed in 1605 and 1608. If the direction of the dividing line is closer to dir2, polynomial B performs outer loop operations, 1736, and it is listed in 1606, 1608.

In cutting out the portion of video inside a soft-edge heart shape, the pixels of the source video located inside the heart shape is identified and colors of these pixels are modified based on the value of a polynomial function evaluated at the pixel locations. Most pixels inside the heart shape are opaque. However, in heart shape cutouts, the closer a pixel is to the edge, the higher its transparency. This gives the heart shaped cutout a soft-edge border.

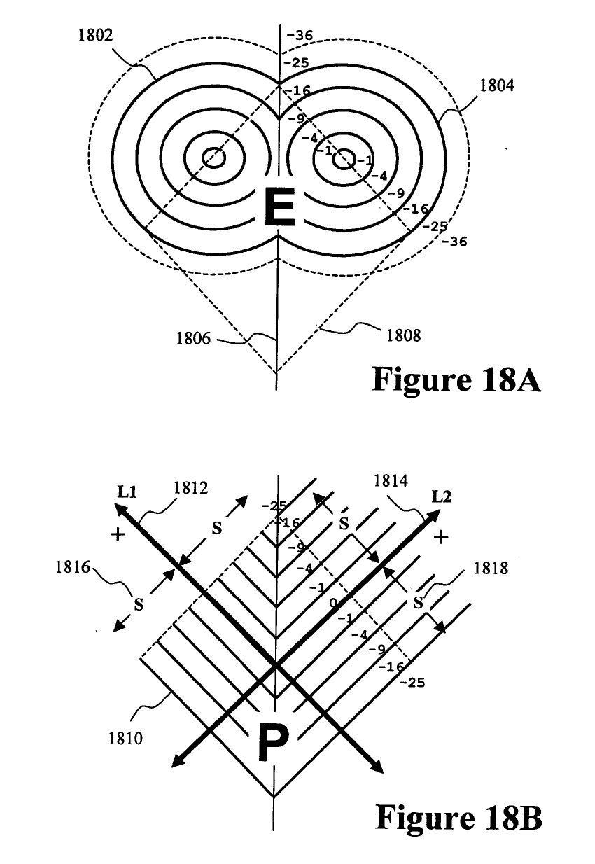

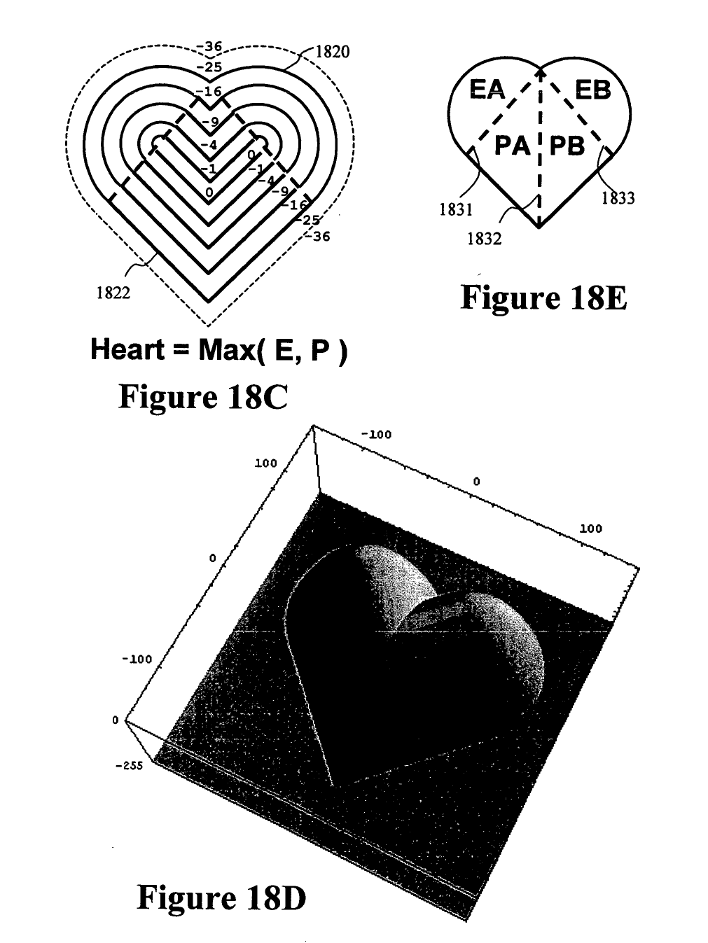

FIG. 18 illustrates one way of creating such a 3D-like soft-edge heart shape video effect by using parallelogram warping, three sets of two second-order polynomial functions, and a dividing line to define a multi-polynomial area. This 3D-like flying heart video effect is created using a combination of second-order polynomial functions as a blending ratio to blend pixels from Video source 1 and pixels from background video source. When using parallelogram warping on the heart shape, we not only evaluate the polynomial values at the sample point, but also we compute the sample point's coordinate and use it as the coordinate of the source pixel in the source video. As a result, the source video inside the heart shape and the heart shape itself are both warped together.

FIG. 18A shows a vertical mirror line, 1806. Two families of ellipses, 1802, 1804, (i.e. second-order polynomials) are mirror reflection of each other. Let's call them together, function E. In FIG. 18B, a rhombus area, 1810, contains two parabolic cylinders (i.e. second-order polynomials) and are mirror reflections of each other. Let's call them together, function P. The rhombus area is defined using each pixel's distances to the two center lines of the rhombus, L1 and L2, 1812 and 1814. If either of the two distances is greater than “S”, 1816, 1818, it is outside the rhombus area, and function P is set to zero. The heart shape is created by MAX (E, P). This is illustrated in FIG. 18C and FIG. 18D.

Since the heart shape may be rotated by parallelogram warping its mirror (reflecting polynomial function pairs such as the two-ellipses pair, or the two-parabolic cylinders pair) should be rendered via the multi-polynomial evaluation method. In both cases, the mirror line is the dividing line separating the screen into two areas each having a different polynomial function. As a result, the two ellipses share the same polynomial computation hardware for the output video. In addition, the two parabolic cylinders share another polynomial computation hardware for the output video. Without the multi-polynomial evaluation method, each ellipse or parabolic cylinder needs its own polynomial computation hardware for the output video.

The method to evaluate the outer loops in the “multi-polynomial” area defined in FIG. 12C is similar to the method described for FIGS. 14, 15, 16, and 17. When a straight line is used to partition the video screen, two alternative directions need to be explored to determined which scan point is the one splitting an inner loop. Incremental distance calculation and Switch Count calculation are the same as in FIG. 16.

In FIG. 12C, polynomial function A is always at the beginning of every inner loop, and therefore, follows the algorithm in FIG. 2 and FIG. 5. Polynomial function B always starts its inner loop from line 1237 and its outer loop is evaluated based on 2 vectors, v_{B1} and V_{B2}, as described in FIG. 16 and FIG. 17. The upper parts of the area for polynomial function C starts its inner loop from line 1236, its outer loop is evaluated based on two vectors, v_{C1} and v_{C2}. The Lower parts of the area for polynomial function C starts its inner loop from a different line, line 1238, therefore, its outer loop is evaluated based on another 2 vectors, v_{C3} and v_{C4}. As a result, in this illustration, the outer loop of polynomial function C is evaluated based on four vectors, v_{C1}, v_{C2}, v_{C3} and v_{C4}.

In FIG. 18E, EA, EB, PA, PB are four different polynomial functions for the four non-overlapping areas separated by 3 dividing lines 1831, 1832, 1833. Using method described for FIG. 12C, the multi-polynomial evaluation method may be extended to evaluate all four polynomial functions EA, EB, PA, PB by sharing a single polynomial computation hardware.

Video special effects usually involve several polynomial functions such as the 4-arm highlight example in FIG. 10 and the heart shape example in FIG. 18. Under illustrated embodiment of the invention, the polynomial processing system uses a single higher order polynomial engine to process a single high order polynomial in one cycle or multiple lower order polynomials in one cycle. It also processes multiple polynomial functions sequentially. It is also capable of evaluating different polynomials in different regions of the image.

In addition, under the illustrated embodiment of the invention, the polynomial processing system uses “state memory” to store polynomial intermediate values, or state of computation. The state memory stores the following:
Stores higher order polynomials using multiple entries of the state memory
Stores self-test polynomials and their expected final states
Stores polynomials for multiple output video frames in an output video sequence.
Stores an extra copy of the polynomial's initial state for re-initialization later

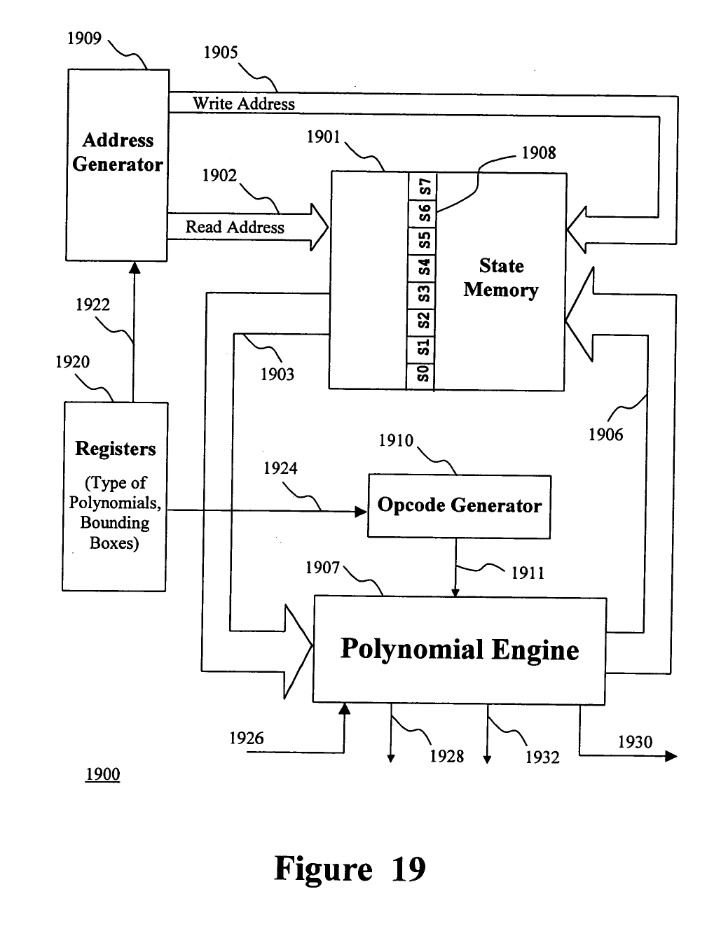

FIG. 19 shows the block diagram of the polynomial processing system. It consists of a Polynomial Engine, 1907, a storage device, called state memory, 1901, an Address Generator, 1909, and an Opcode Generator, 1910. The state memory contains all polynomial intermediate values, or state of computation, for all polynomials required for rendering the current frame. In this embodiment, the state memory is a dual port memory. It has a read port for reading a memory location, and a write port for writing a memory location.

In order to process inner loop operations of higher order polynomials in one cycle, eight intermediate values are stored in parallel in the state memory. Lets call them state values, S[0] to S[7], 1908.

The Polynomial Engine, 1907, performs all incremental operations during the inner loop and outer loop. The Polynomial Engine and state memory are operated at a rate several times faster than the pixel rate of output video. As a result, the Polynomial Engine and state memory is capable of processing several inner loop operations of different polynomials sequentially during the processing time of one pixel (one pixel time).

During the inner loop, the Polynomial Engine sequentially receives the inner loop intermediate values for multiple polynomials stored in the state memory through the bus connection, 1903. It sequentially performs the inner loop incremental operations, and returns the results back to the state memory through the bus connection, 1906. During this time, Address Generator, 1909, generates read addresses and write addresses of inner loop intermediate values and sends the addresses to state memory. The Address Generator makes sure only those polynomials whose bounding box contains the current output pixel position will be sent to polynomial engine for inner loop operation. The Opcode Generator generates inner loop opcode. All inner loop operations are performed during one pixel time.

During the non-rendering time between scan lines, a single outer loop operation is performed for each of the rendered polynomials. The polynomial Engine retrieves outer loop intermediate values from the polynomials stored in the state memory through the connection, 1903. It sequentially performs the outer loop incremental operations and transfer operations, and returns the results back to the state memory through the connection, 1906. During this time, the Address Generator, 1909, generates read addresses and write addresses of intermediate values and sends the addresses to the state memory. The Address Generator makes sure only those polynomials whose bounding box intersects the current scan line will be sent to the polynomial engine for outer loop operation.

The Opcode Generator generates opcodes such as inner loop, outer loop, and memory copy. The results of the polynomial evaluation are available at 1932 during the inner loop operation. Additional outputs such as the direction flag and the Switch Count are available at 1928.

During the time between two video fields, the state memory is reloaded with new polynomial initialization data for the next video field. During the reloading, data is delivered via the input 1926. Output 1930 is used to observe the content of the state memory during testing.

Bounding box information does not change from pixel to pixel, and is stored in register, 1920. It is used by the Address Generator and the Opcode Generator to control inner loop and outer loop operations depending on whether the current pixel is in the bounding box or not.

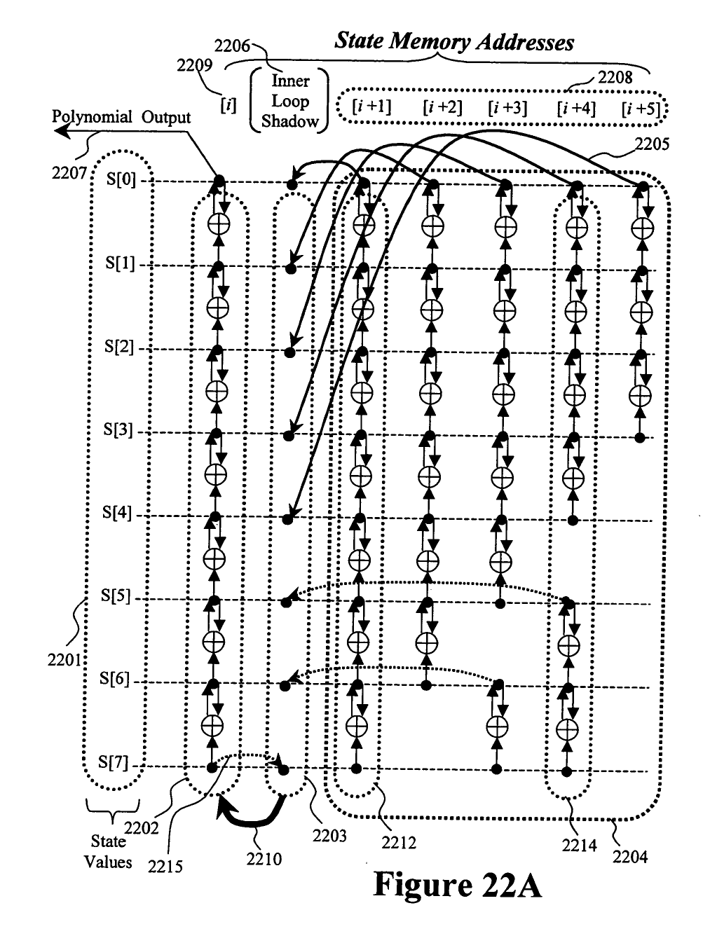

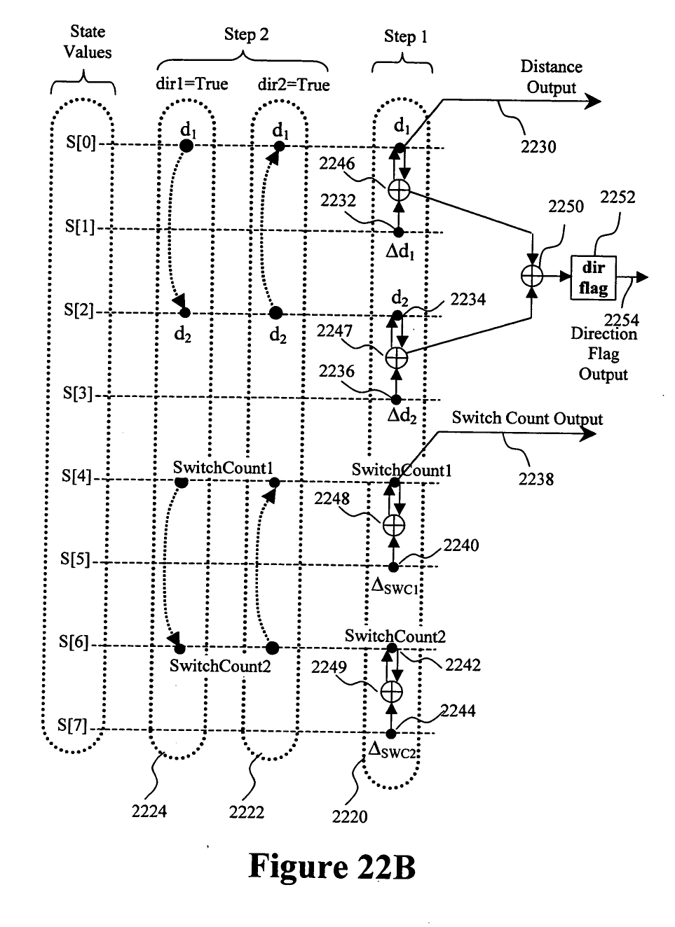

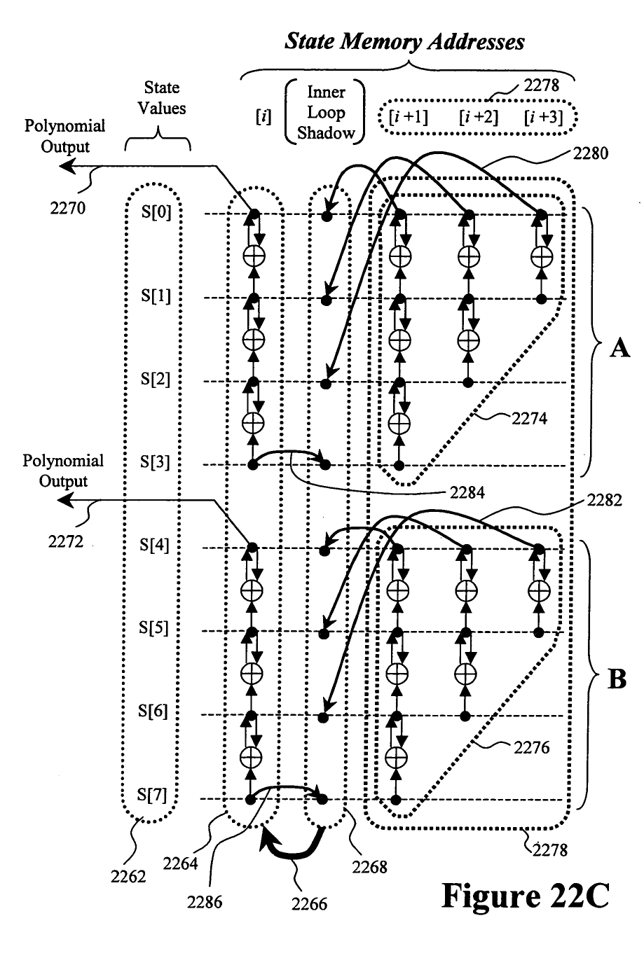

FIG. 22A shows a micro-operation sequence to perform incremental computation for a seventh-order polynomial function across an arbitrary parallelogram scanning area. Consider extending the data flow diagram for a fourth-order polynomial function in FIG. 2D to a 7th order polynomial function, the triangle shape data flow diagram will have 7 “+”, or incremental computation, on the top, and 7 “+” on the left. The seven “+” on the top is for the inner loop operation. Since state memory stores eight state values per memory location, it is capable of computing the seven “+” of the inner loop operation in a single clock cycle. However, its outer loop consists of many more intermediate values and “+” operations. It takes several memory locations to store all outer loop intermediate values and several clock cycles to perform outer loop add operation.

S[0] to S[7], 2201, in FIG. 22A represent the eight “state values” stored in the state memory. The seven incremental operations, 2202, are the inner loop micro-operation. Lets call “[i]”, 2209, the memory location storing the inner loop intermediate values. The output polynomial values are available at the S[0], 2207. The twenty-eight incremental operations, 2204, are the outer loop incremental micro-operations. The outer loop intermediate values are stored in several memory locations in the state memory, [i+1] to [i+5], 2208.

A “single state value copying” micro-operation from one memory location to another, or in short, a “transfer” micro-operation, is shown as arrows, such as 2205. A “memory copying” micro-operation of all state values from one memory location to another in a single cycle is shown as thick arrow, 2210.

A memory location called “inner loop shadow”, 2206, holds the inner loop starting values. Inner loop shadow memory location is used when performing single cycle re-initialization during rendering by a memory copying micro-operation. At the end of outer loop add operations, 2204, the inner loop shadow is updated by eight transfer micro-operations such as 2205 and 2215. Once updated, it is ready for a single cycle re-initialization, 2210.

FIG. 22B illustrates the extra operations needed during the multi-polynomial evaluation method. It chooses either direction 1 or direction 2 to reach the next switch point. It also computes the Switch Count corresponding to the direction.

Under the illustrated embodiment of this invention, a dividing line is used to partition the video screen into two areas, one for each polynomial function. As a result, near the dividing line, two alternative directions needs to be explored to determine which scan point is the one dividing an inner loop for the two polynomial functions. For each of the two possible directions, a new distance and the new Switch Count need to be calculated. The adders 2246 and 2247 in FIG. 22B compute new distances. The adders 2248 and 2249 compute new Switch Counts. The two new distances are compared by an adder, 2250, operated as a subtracter. The sign bit of the difference indicates which distance is smaller and is stored as a direction flag in a register, 2252.

Once the direction is determined, both state values for storing the distance should include the corrected distance. In addition, both state values for storing the Switch Count would include the corrected Switch Count. In case of direction 1, this is done by two “transfer” micro-operations: (1) transferring the corrected distance from S[0] to S[2] and (2) transferring the corrected Switch Count from S[4] to S[6], as shown in 2224. In case of direction 2, this is also done by two “transfer” micro-operations: (1) transferring the corrected distance from S[2] to S[0] and (2) transferring the corrected Switch Count from S[6] to S[4], as shown in 2222. Each of these “transfer” micro-operations is performed the same way as 2205 in FIG. 22A.

FIG. 22C illustrates a micro-operation sequence to perform incremental computation for two third-order polynomial functions, A and B. Operations specified in the data flow diagram in FIG. 2C are directly mapped to micro-operations in FIG. 22C. Inner loop add operations, 222 in FIG. 2C, are computed by single inner loop micro-operation 2264. Outer loop add operations in 224, which are corresponding to 2274 and 2276, are performed by three micro-operations, 2278. After outer loop add operations, the inner loop shadow is updated by eight transfer micro-operations such as 2280, 2282, 2284, and 2286. Once updated, it is ready for single cycle re-initialization, 2266. Since the two third-order polynomial functions, A and B, shares the same state memory addresses, they are always processed together.

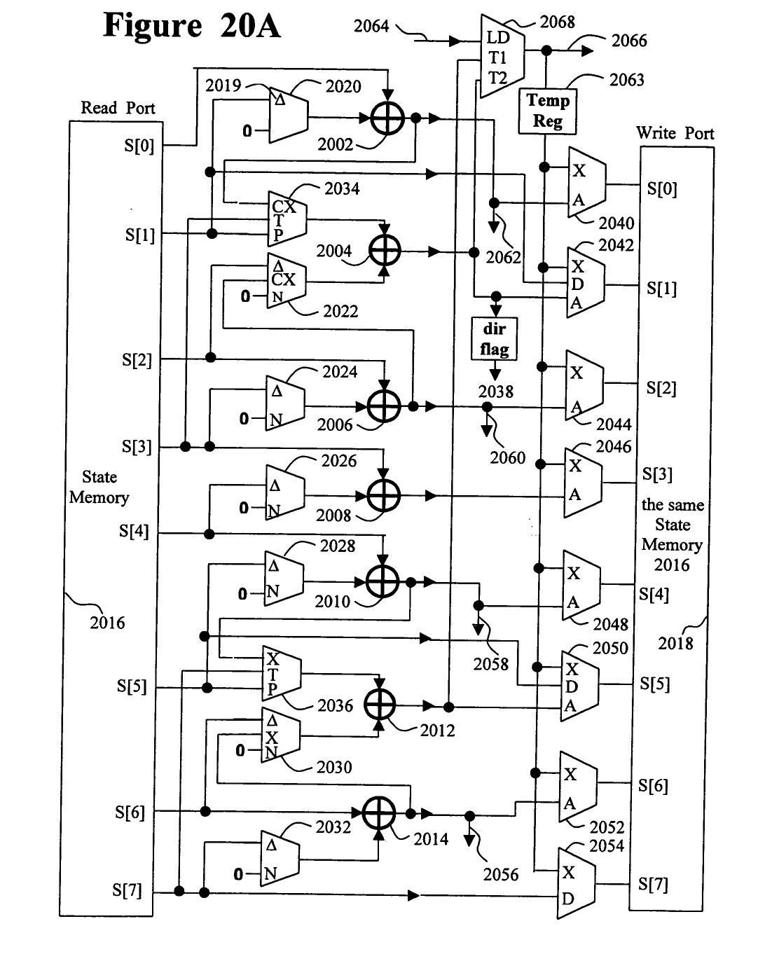

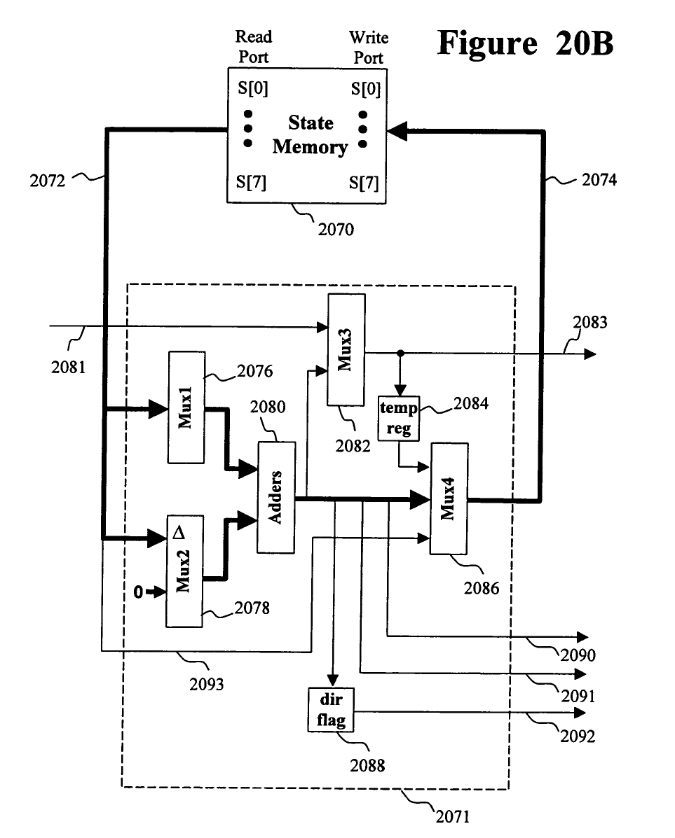

FIG. 20A shows a block diagram of the Polynomial Engine. The Polynomial Engine consists of seven adders, 2002 to 2014. It computes new intermediate values and output values based on older intermediate values stored inside the state memory, available at the read port of the state memory, 2016. Then, it stores the new intermediate values back to the state memory, via write port of the state memory, 2018. It can perform the inner loop operation of up to a seventh-order polynomial function in one cycle. It can also process the inner loop operation of a multiple lower order polynomial functions in a single cycle.

When the adders are used for incremental computation, the two operands of each adder are aligned with an offset by several bit positions. This is necessary since a delta value is added to an accumulator value hundreds of time during the inner loop and outer loop. These delta values, as labeled “A” on the inputs of the multiplexers 2020 to 2032, for example 2019, are typically much smaller than the accumulated sum values. These delta values need more bits to represent their fraction part, and need less bits to represent their integer part of their values. Therefore, the higher bits of the delta value should be aligned to the lower bits of the accumulated sum values. This way, the portion of state memory that stores the delta values can have a different decimal point position than the portion of state memory that stores the accumulated sum values.

The adder 2004 can also be used to compare distances within a multi-polynomial area to determine the direction dir1 or direction dir2 as described in FIG. 14 and FIG. 22B. The multiplexers 2020 to 2032 select one operand of the adders for incremental operations.

This operand is usually either zero or a delta value. The two multiplexers 2034, and 2036 select the other operand of the adder 2004 and 2012. The multiplexers 2040 to 2054 determine what data is to be stored back to the state memory. The multiplexer 2068 and the Temp Register 2063 provide a data path to transfer any single state value from any location in the state memory to use with any other state values of another memory location by temporarily storing its state value in the temporary register 2063.

An external input, 2064, is used to load the polynomial data during the state memory initialization. It inputs one state value at a time. An external output, 2066, is used to observe the content of the state memory during testing. The polynomial evaluation results are available at 2056 to 2062. Sometimes, other values are outputted, e.g. during the use of the multi-polynomial evaluation method. Switch Count output is available at 2058.

FIG. 20B is a simplified version of the FIG. 20A. It is used to illustrate various operations performed by the Polynomial Engine to support the multi-polynomial evaluation method. The Polynomial Engine, 2071, receives state values stored in state memory via connection 2072. It stores the new state values back to the state memory via connection 2074. Four types of outputs from the polynomial engine are: polynomial evaluation output, 2090, Switch Count output, 2091, direction flag output, 2092, and the state memory content, 2083.

Multiplexers 2020 to 2032 in FIG. 20A are represented by Mux2, 2078. Multiplexers 2034 and 2036 are represented by Mux1, 2076. Adders 2002 to 2014 are represented by Adders, 2080. Multiplexers 2040 to 2054 in FIG. 20A are represented by Mux4, 2086. Multiplexer 2068 is represented by Mux3, 2082.

The following explains how polynomial engine performs five operations in details.

1. To perform seventh-order polynomial inner loop micro-operation, 2202, or outer loop micro-operation, 2212, in FIG. 22A, the Mux2, 2078, selects the Δ input for all seven adders. The Mux4 selects the output of the seven adders 2080, and the S[7] in 2072 as the new values to be stored back to the state memory.

2. To perform seventh-order polynomial outer loop micro-operation, 2214, in FIG. 22A, the Mux2, 2078, selects the A input for six adders. The Multiplexer 2028 in FIG. 20A selects zero as its input. This ensures the adder 2010 keeps the S[4]'s old value when S[4] is stored back to the state memory.

3. To perform “transfer” operation 2205 in FIG. 22A, from S[0] of memory location [i+5] to S[4] of “Inner Loop Shadow” memory location, this illustrated embodiment performs the transfer operation in two steps: a “From S[0]” step and a “To S[4]” step.

In the “From S[0]” step, S[0]'s state value from memory location [i+5] is stored in the temporary register. This requires the coordinated operation of multiplexers. Mux 1, Mux2 and adder ensures the S[0] reaches Mux3, 2082. Mux3 selects S[0] and stores S[0] in Temp Register, 2084.

At the following clock cycle, the “To S[4]” step is performed. The “Inner Loop Shadow” memory location is read; its state values are at the inputs of the Mux1 and Mux2. In this step, Mux2, 2078, selects zero to ensure that S[0] to S[7] not altered by any adder. Mux4, 2086 selects S[0] to S[7], i.e. the original state values, from the outputs of the seven adders, 2080, except for the S[4]. To replace S[4], Mux4 selects the output of the Temp Register, 2084, which keeps the S[0] state value of the memory location [i+5]. As the data written back to the “Inner Loop Shadow” memory location, the transfer operation is completed.

4. To perform “memory copying” operation, 2210, in FIG. 22A, all state values S[0] to S[7] at the “Inner Loop Shadow” memory location is copied to the S[0] to S[7] of the inner loop intermediate values at memory location [i] in a single clock cycle. Mux2, 2078, selects zero to ensure that S[0] to S[7] are not altered by any adder. Mux4, 2086, selects the original state values S[0] to S[6] from the outputs of the seven adders, 2080, and S[7] from connection 2072. Once the data is written back to the memory location [i], the memory copying operation is completed.

5. To determine the direction flag and the next Switch Count, 2220, in FIG. 22B, four addition operations are performed, 2246 to 2249. These additions are performed by adders 2002, 2006, 2010, and 2014 in FIG. 20A respectively.

Subtraction operation, 2250, finds the direction closer to the dividing line and stores the direction flag in a register. The adder 2004 in FIG. 20A finds the difference between the sums from adders 2002 and 2006. The multiplexers 2034 and 2022 select the sums as the operands of adder 2004 through their CX inputs. In this operation, the adder is configured to perform subtraction. The sign bit of the difference indicates which distance is smaller and is stored as direction flag in the direction flag register, 2038. The operations 2222 and 2224 in FIG. 22B are the transfer micro-operations as has already been described above.

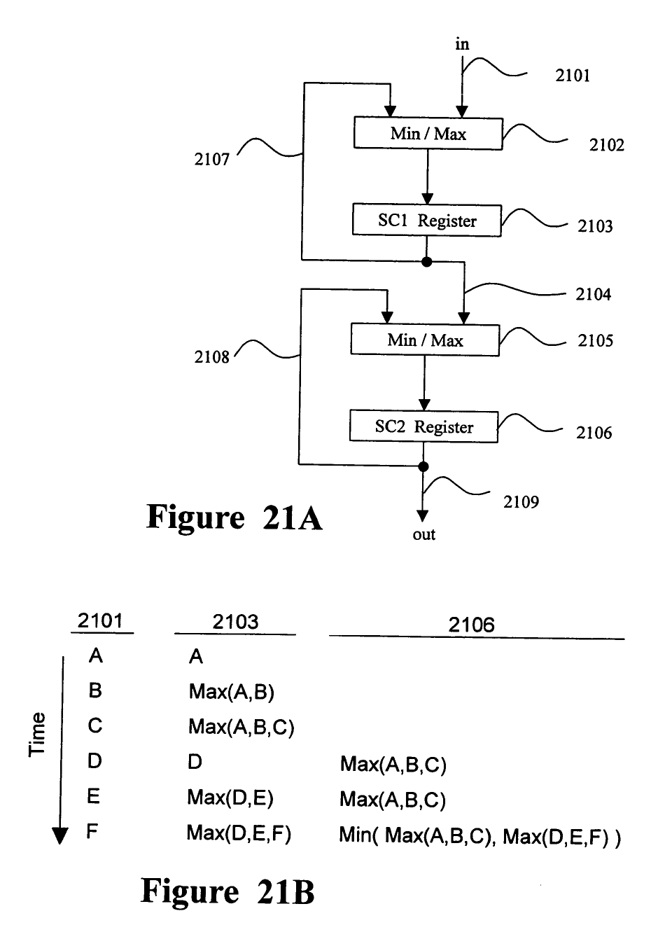

FIG. 21A shows a block diagram of the shape combination module. The shape combination module combines the polynomial values sequentially. It allows two levels of MIN and MAX operations. The input of 2101 is connected to polynomial value output at 1932 in FIG. 19. As the polynomial value arrives sequentially, the minimum and maximum comparison is performed. In addition, the SC1 register, 2103, stores the current min or max values. Its value is used to compare against new polynomial input.

The second stage, 2105 and 2106 are used to perform min or max operation after the first stage. The SC2 register, 2106, stores the current min or max values of the second stage. Its value is used to compare against the result of the first stage.

The shape combination module is controlled according to an equation specified by each video special effect, such as the one listed in FIG. 10C or FIG. 18C. The final output is available at 2109.

FIG. 21B illustrates the operation of the shape combination module. Lets assume a video special effect needs to combine 6 polynomial functions A, B, C, D, E and F in the following way:
Final value=Min(Max(A, B, C), Max(D, E, F)

As the six polynomial functions been evaluated sequentially, their values arrive at the input, 2101, of the shape combination module in this order: A, B, C, D, E and F.

As A arrives at input, A is stored in SC1 register.

As B arrives at input, B is compared against SC1 register, and Max(A,B) is stored in SC1 register.

As C arrives at input, C is compared against SC1 register, and Max(A,B,C) is stored in SC1 register.

As D arrives at input, Max(A,B,C) is stored in SC2 register, and D is stored in SC1 register.

As E arrives at input, E is compared against SC1 register, and Max(D,E) is stored in SC1 register.

As F arrives at input, F is compared against SC1 register, and Max(D,E,F) is stored in SC1 register.

Next cycle, Max(D,E,F) from SC1 register is compared against SC2 register. The output, 2109, is the smaller of the two:
Output value=Min(Max(A, B, C), Max(D, E, F)

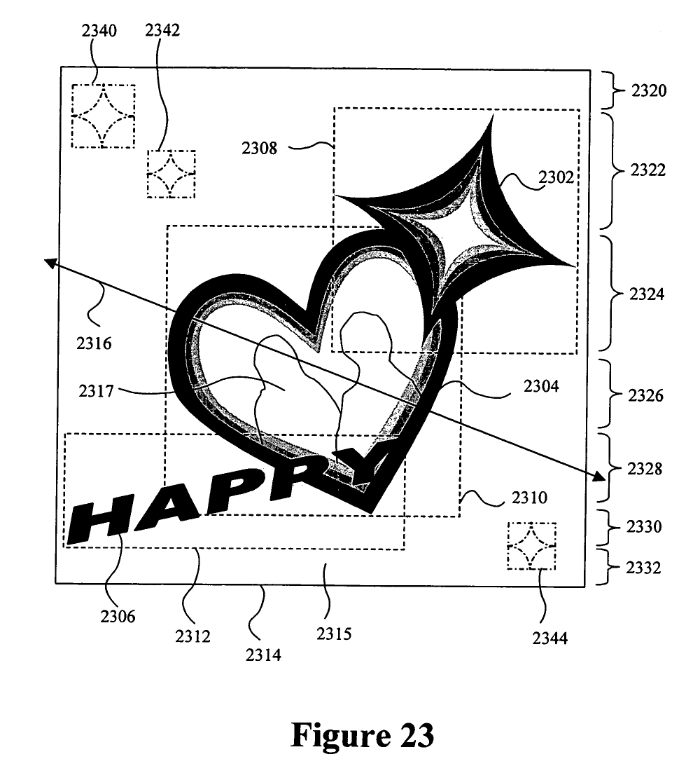

In the case of highlight example in FIG. 10C, the output at 2109 is used as the blending ratio between the output pixel color and the white. In the case of the heart shape video example in FIG. 18C, the output at 2109 is used as the blending ratio between source video 1 and the background video. In the case of parallelogram warped video inside the heart shape in FIG. 23, the output at 2109 is used as the coordinate of the source video. In case of gradient color generation application, the output at 2109 is used as the color of a source video.

FIG. 23 illustrates an example of output video containing three source objects: a 3D soft-edge heart shape video cutout, 2304, a rotating highlight, 2302, and an animated word filled with gradient color, 2306. Each of the three objects has a bounding box, 2310, 2308, 2312, respectively. In this illustration, there are four layers of video blended together: background source video on the bottom layer, the heart shape source video on the next layer, the animated word at the next layer above, and the 4-arm highlight at the top layer. The steps to create a 3D-like soft-edge heart shape video cutout were illustrated in FIG. 18 already. The steps to create a rotating highlight were illustrated in FIG. 10. The following describe the steps to create an animated word filled with gradient color.

A gradient color is a smooth transition from one color to another color. The smooth change of polynomial function may be used to produce gradient color. The color of a particular pixel located inside the face of the characters of the word is decided based on the value of a polynomial function evaluated at the pixel location. The gradient color on the character faces may change as the parameters of the polynomial function changes over time.

In this illustration, the face pixels of the word are identified by a “face bitmap” stored in video source N, 18 in FIG. 1. The face bitmap defines which pixel is inside the character, and which pixel is outside the character. For the pixels near the edge of the character, which may be partially inside the character, this bitmap specifies the percentage of a pixel that is inside the character.

Adding an animated word filled with a gradient color to the output video may be done by evaluating two sets of polynomials. The first set of polynomials defines the texture mapping for the face bitmap, and applying parallelogram warping to it to produce animation. The second set of polynomials defines the gradient color. Instead of obtaining color from a source video, the polynomial processing system in FIG. 19 generates the color as the source video.

The controller 12 in FIG. 1 renders this output video by generating output pixel one scan line at a time from the upper left corner to the lower right corner of the output video image. Scan lines in the ranges 2320 and 2332 are not needed to evaluate any polynomial. Scan lines in the ranges 2322, 2326 and 2330 only evaluate polynomials needed for highlight effect, heart shape effect, and gradient colored word effect respectively. That means across the scan line, at least one inner loop operation is performed, and, at the end of these scan lines, outer loop operations for the relevant polynomials are also performed.

Scan lines in the range 2324 evaluate polynomials for both highlight effect and heart shape effect. Near the edge of the heart shaped object, 2304, its polynomial value is used to blend the source video inside the heart shape, 2317, with the background video, 2315.

Since the star highlight, 2302, is at the top layer, its polynomial value is used to blend white color with heart shaped object, 2304, wherever they overlap. In other area, the white color is blended with the background video, 2315.

Scan lines in the range 2328 evaluate polynomials for both heart shape effect and gradient colored word effect. Since the gradient colored word effect, 2306, is at the layer above the heart shaped object, only the gradient colored word is rendered wherever they overlap.

An alternative way to increase rendering efficiency is applying the “multi-polynomial evaluation method” by using a dividing line such as 2316. The polynomials for gradient colored word effect are evaluated on one side of this dividing line while the polynomials for highlight effect are evaluated on the other side of this dividing line.

If we add more polynomial functions inside several isolated bounding boxes such as 2340, 2342, 2344, no additional polynomial evaluation hardware is needed. These additional highlights, 2340, 2342 and 2344, can share the same polynomial evaluation hardware with the existing polynomials for the heart shape, 2304, the large highlight, 2302, and the word, 2306.

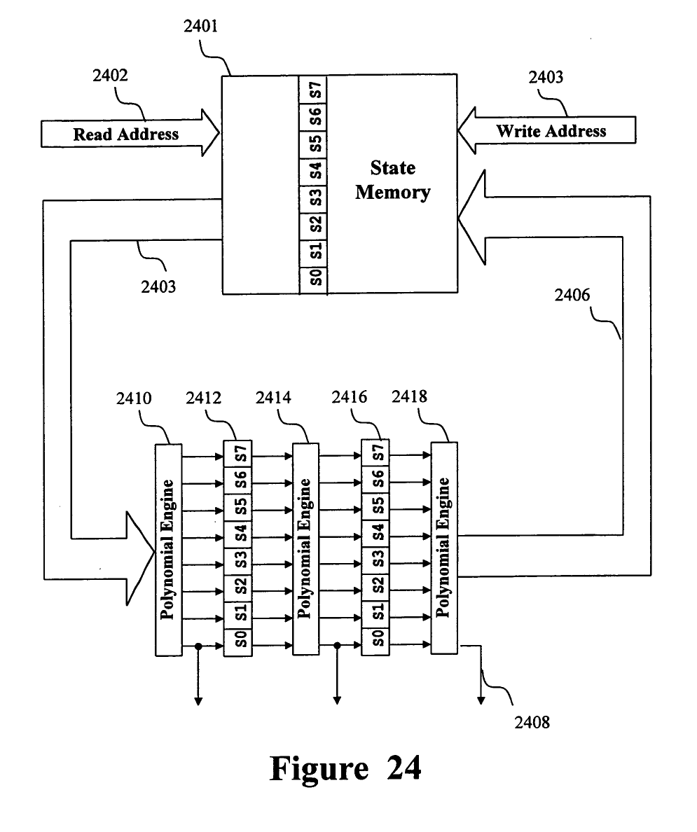

To add all the video special effects to the output video in FIG. 23 requires the evaluation of many polynomial functions. Under the illustrated embodiment of the invention, a pipelined polynomial processing system illustrated in FIG. 24 is used to increase the throughput of the polynomial computation without increasing the operating frequency of the system.

In this illustration, the pipelined polynomial processing system consists of three polynomial engines, 2410, 2414, 2418, with pipeline registers between the polynomial engines, 2412, 2416. During the inner loop operation, polynomial's inner loop intermediate values are retrieved from the state memory, and are used to evaluate the polynomial function for three consecutive pixels positions before writing back to the state memory. Three shape combination modules are used. Each is responsible for combining the values of different polynomials sequentially for a single pixel. As a result, the pipelined polynomial processing system increases the throughput of the polynomial computation by generating three sets of “shape combined” polynomial values simultaneously.

A specific embodiment of method and apparatus for rendering images has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method for rendering a video image to a destination image space from a plurality of source image spaces, such method comprising the steps of:
generating a set of loop intermediate values from one or more polynomials;
incrementally evaluating polynomials within a parallelogram-shaped loop processing area of a source or a destination image space along an inner and an outer processing loop based upon the generated set of loop intermediate values; and
rendering a destination image space based upon the evaluated polynomials from the inner and outer loops.

2. The method for rendering the video image as in claim 1 wherein the loop intermediate values further comprise inner loop intermediate values, outer loop intermediate values and inner loop starting values.

3. The method for rendering the video image as in claim 2 wherein the intermediate values further comprise providing a vector U for generating the inner loop intermediate values.

4. The method for rendering the video image as in claim 3 wherein the intermediate values comprise providing a vector V for generating the outer loop intermediate values.

5. The method for rendering the video image as in claim 2 wherein the step of incrementally evaluating further comprises incrementing intermediate polynomial values along the inner loop by the inner loop intermediate values.

6. The method for rendering the video image as in claim 2 wherein an initial value of the intermediate polynomial value along the inner loop further comprises an inner loop starting value of the starting values.

7. The method for rendering the video image as in claim 6 wherein the step of incrementally evaluating further comprises incrementing an intermediate polynomial value along the outer loop by the outer loop intermediate value.

8. The method for rendering the video image as in claim 1 wherein the incrementally evaluated polynomials further comprise a non-additive combination of the evaluated polynomials within the loop processing area.

9. The method for rendering the video image as in claim 8 further comprising retrieving pixels from a source image space based upon the non-additive combination of evaluated polynomials within the loop processing area.

10. The method for rendering the video image as in claim 8 further comprising rendering color within a portion of the video image based upon the non-additive combination of evaluated polynomials.

11. The method for rendering the video image as in claim 8 further comprising blending a plurality of colors within a portion of the video image based upon the non-additive combination of evaluated polynomials.

12. The method for rendering the video image as in claim 8 further comprising blending pixels from a plurality of source objects using the non-additive combination of polynomials.

13. The method for rendering the video image as in claim 1 further comprising defining a destination area within the destination image space where pixels are rendered under the polynomial based upon operation of the inner and outer loop.

14. The method for rendering the video image as in claim 13 further comprising defining a parallelogram as the destination area where the polynomial is evaluated within the destination image space.

15. The method for rendering the video image as in claim 14 further comprising determining a source pixel coordinate for each destination pixel within a destination area of the parallelogram by calculating its distance from two sides of the destination area of the parallelogram.

16. The method for rendering the video image as in claim 15 further comprising warping the rendered video by changing a shape of the parallelogram.

17. The method for rendering the video image as in claim 13 further comprising defining a bounding box within the destination image space that substantially covers the destination area where the pixels are rendered under the polynomial based upon operation of the inner and outer loops.

18. The method for rendering the video image as in claim 1 further comprising providing dividing lines inside the loop processing area and evaluating a set of intermediate values on opposing sides of the dividing lines using a different polynomials of the evaluated polynomials on opposing sides of each of the dividing lines.

19. The method for rendering the video image as in claim 18 further comprising incrementally computing a distance from a processing point to a dividing line of the dividing lines and determining a switching point in the inner processing loop based upon the distance.

20. The method for rendering the video image as in claim 18 further comprising determining two or more vectors for generating outer loop intermediate values for a polynomial of the evaluated polynomials.

21. The method for rendering the video image as in claim 18 wherein the incrementally evaluated polynomials further comprise a non-additive combination of the evaluated polynomials within the loop processing area.

22. An apparatus for rendering a video image to a destination image space from a plurality of source image spaces, such apparatus comprising:
a set of loop intermediate values generated from one or more polynomials;
a polynomial processor that incrementally evaluates polynomials within a parallelogram-shaped loop processing area of a source or a destination image space along an inner and an outer processing loop based upon the generated set of loop intermediate values; and
a source video controller that renders pixels into the destination image space based upon the polynomials evaluated by the polynomial processor.

23. The apparatus for rendering the video image as in claim 22 wherein the loop intermediate values further comprise inner loop intermediate values, outer loop intermediate values and inner loop starting values.

24. The apparatus for rendering the video image as in claim 23 wherein the intermediate values further comprise providing a vector U for generating the inner loop intermediate values.

25. The apparatus for rendering the video image as in claim 24 wherein the intermediate values comprise providing a vector V for generating the outer loop intermediate values.

26. The apparatus for rendering the video image as in claim 23 wherein the polynomial processor further comprises a state memory that stores intermediate polynomial values along the inner loop by the inner loop intermediate values.

27. The apparatus for rendering the video image as in claim 23 wherein an initial value of the intermediate polynomial value along the inner loop further comprises an inner loop starting value of the starting values.

28. The apparatus for rendering the video image as in claim 27 wherein the polynomial processor further comprises a state memory that stores intermediate polynomial values that have been incremented along the outer loop by the outer loop intermediate value.

29. The apparatus for rendering the video image as in claim 22 wherein the incrementally evaluated polynomials further comprise a non-additive combination of the evaluated polynomials within the loop processing area.

30. The apparatus for rendering the video image as in claim 29 further comprising a first non-additive polynomial combination that retrieves pixels from a source image space based upon the non-additive combination of evaluated polynomials.

31. The apparatus for rendering the video image as in claim 29 further comprising a second non-additive polynomial combination that rendering color within a portion of the video image based upon the non-additive combination of evaluated polynomials.

32. The apparatus for rendering the video image as in claim 29 further comprising a third non-additive polynomial combination that blends a plurality of colors within a portion of the video image based upon the non-additive combination of evaluated polynomials.

33. The apparatus for rendering the video image as in claim 29 further comprising a fourth non-additive polynomial combination that blends pixels from a plurality of source objects using the non-additive combination of polynomials.

34. The apparatus for rendering the video image as in claim 22 further comprising defining a destination area within the destination image space where pixels are rendered under the polynomial based upon operation of the inner and outer loop.

35. The apparatus for rendering the video image as in claim 34 further comprising a parallelogram defined as the destination area where the polynomial is evaluated within the destination image space.

36. The apparatus for rendering the video image as in claim 35 further comprising determining a source pixel coordinate for each destination pixel within a destination area of the parallelogram by calculating its distance from two sides of the destination area of the parallelogram.

37. The apparatus for rendering the video image as in claim 36 further comprising the rendered video that has been warped by changing a shape of the parallelogram.

38. The apparatus for rendering the video image as in claim 34 further comprising a bounding box defined within the destination image space that substantially covers the destination area where the pixels are rendered under the polynomial based upon operation of the inner and outer loops.

39. The apparatus for rendering the video image as in claim 22 further comprising a set of dividing lines inside the loop processing area and a set of intermediate values that are evaluated on opposing sides of the dividing lines using a different polynomials of the evaluated polynomials on opposing sides of each of the dividing lines.

40. The apparatus for rendering the video image as in claim 39 further comprising a distance processor that incrementally computes a distance from a processing point to a dividing line of the dividing lines and determining a switching point in the inner processing loop based upon the distance.

41. The apparatus for rendering the video image as in claim 39 further comprising two or more vectors that generate outer loop intermediate values for a polynomial of the evaluated polynomials.

42. The apparatus for rendering the video image as in claim 39 wherein incrementally evaluated polynomials further comprise a non-additive combination of the evaluated polynomials within the loop processing area.

43. The apparatus for rendering the video image as in claim 22 further comprising a first micro-operation sequence that evaluates a first polynomial and a second micro-operation sequence that evaluates a second polynomial.

44. The apparatus for rendering the video image as in claim 22 further comprising a state memory that simultaneously stores intermediate values of a plurality of polynomials.

45. The apparatus for rendering the video image as in claim 22 wherein the polynomial processor further comprises a plurality of pipelined polynomial processors that simultaneously evaluate a plurality of polynomials.

46. A method for rendering a video image to a destination image space from a plurality of source image spaces, such method comprising the steps of:
generating a set of loop intermediate values from one or more second order or higher polynomials;
incrementally evaluating the polynomials within a loop processing area of a source or a destination image space along an inner and an outer processing loop based upon the generated set of loop intermediate values; and
rendering a destination image space based upon the evaluated polynomials from the inner and outer loops.

47. The method for rendering the video image as in claim 46 wherein the loop intermediate values further comprise inner loop intermediate values, outer loop intermediate values and inner loop starting values.

48. The method for rendering the video image as in claim 47 wherein the intermediate values further comprise providing a vector U for generating the inner loop intermediate values.

49. The method for rendering the video image as in claim 48 wherein the intermediate values comprise providing a vector V for generating the outer loop intermediate values.

50. The method for rendering the video image as in claim 47 wherein the step of incrementally evaluating further comprises incrementing intermediate polynomial values along the inner loop by the inner loop intermediate values.

51. The method for rendering the video image as in claim 47 wherein an initial value of the intermediate polynomial value along the inner loop further comprises an inner loop starting value of the starting values.

52. The method for rendering the video image as in claim 51 wherein the step of incrementally evaluating further comprises incrementing an intermediate polynomial value along the outer loop by the outer loop intermediate value.

53. The method for rendering the video image as in claim 46 wherein the incrementally evaluated polynomials further comprise a non-additive combination of the evaluated polynomials within the loop processing area.

54. The method for rendering the video image as in claim 53 further comprising retrieving pixels from a source image space based upon the non-additive combination of evaluated polynomials within the loop processing area.

55. The method for rendering the video image as in claim 53 further comprising rendering color within a portion of the video image based upon the non-additive combination of evaluated polynomials.

56. The method for rendering the video image as in claim 53 further comprising blending a plurality of colors within a portion of the video image based upon the non-additive combination of evaluated polynomials.

57. The method for rendering the video image as in claim 53 further comprising blending pixels from a plurality of source objects using the non-additive combination of polynomials.

58. The method for rendering the video image as in claim 46 further comprising defining a destination area within the destination image space where pixels are rendered under the polynomial based upon operation of the inner and outer loop.

59. The method for rendering the video image as in claim 58 further comprising defining a parallelogram as the destination area where the polynomial is evaluated within the destination image space.

60. The method for rendering the video image as in claim 59 further comprising determining a source pixel coordinate for each destination pixel within a destination area of the parallelogram by calculating its distance from two sides of the destination area of the parallelogram.

61. The method for rendering the video image as in claim 60 further comprising warping the rendered video by changing a shape of the parallelogram.

62. An apparatus for rendering a video image to a destination image space from a plurality of source image spaces, such apparatus comprising:
a set of loop intermediate values generated from one or more second order or higher polynomials;
a polynomial processor that incrementally evaluates polynomials within a loop processing area of a source or a destination image space along an inner and an outer processing loop based upon the generated set of loop intermediate values; and
a source video controller that renders pixels into the destination image space based upon the polynomials evaluated by the polynomial processor.

63. The apparatus for rendering the video image as in claim 62 wherein the loop intermediate values further comprise inner loop intermediate values, outer loop intermediate values and inner loop starting values.

64. The apparatus for rendering the video image as in claim 63 wherein the intermediate values further comprise providing a vector U for generating the inner loop intermediate values.

65. The apparatus for rendering the video image as in claim 64 wherein the intermediate values comprise providing a vector V for generating the outer loop intermediate values.

66. The apparatus for rendering the video image as in claim 63 wherein the polynomial processor further comprises a state memory that stores intermediate polynomial values along the inner loop by the inner loop intermediate values.

67. The apparatus for rendering the video image as in claim 63 wherein an initial value of the intermediate polynomial value along the inner loop further comprises an inner loop starting value of the starting values.

68. The apparatus for rendering the video image as in claim 67 wherein the polynomial processor further comprises a state memory that stores intermediate polynomial values that have been incremented along the outer loop by the outer loop intermediate value.

69. The apparatus for rendering the video image as in claim 62 wherein the incrementally evaluated polynomials further comprise a non-additive combination of the evaluated polynomials within the loop processing area.

70. The apparatus for rendering the video image as in claim 69 further comprising a first non-additive polynomial combination that retrieves pixels from a source image space based upon the non-additive combination of evaluated polynomials within the loop processing area.

71. The apparatus for rendering the video image as in claim 69 further comprising a second non-additive polynomial combination that rendering color within a portion of the video image based upon the non-additive combination of evaluated polynomials.

72. The apparatus for rendering the video image as in claim 69 further comprising a third non-additive polynomial combination that blends a plurality of colors within a portion of the video image based upon the non-additive combination of evaluated polynomials.

73. The apparatus for rendering the video image as in claim 69 further comprising a fourth non-additive polynomial combination that blends pixels from a plurality of source objects using the non-additive combination of polynomials.

74. The apparatus for rendering the video image as in claim 62 further comprising defining a destination area within the destination image space where pixels are rendered under the polynomial based upon operation of the inner and outer loop.

75. The apparatus for rendering the video image as in claim 74 further comprising a parallelogram defined as the destination area where the polynomial is evaluated within the destination image space.

76. The apparatus for rendering the video image as in claim 75 further comprising determining a source pixel coordinate for each destination pixel within a destination area of the parallelogram by calculating its distance from two sides of the destination area of the parallelogram.

77. The apparatus for rendering the video image as in claim 76 further comprising the rendered video that has been warped by changing a shape of the parallelogram.

78. The apparatus for rendering the video image as in claim 74 further comprising a bounding box defined within the destination image space that substantially covers the destination area where the pixels are rendered under the polynomial based upon operation of the inner and outer loops.

79. The apparatus for rendering the video image as in claim 62 further comprising a set of dividing lines inside the loop processing area and a set of intermediate values that are evaluated on opposing sides of the dividing lines using a different polynomials of the evaluated polynomials on opposing sides of each of the dividing lines.

80. The apparatus for rendering the video image as in claim 79 further comprising a distance processor that incrementally computes a distance from a processing point to a dividing line of the dividing lines and determining a switching point in the inner processing loop based upon the distance.

81. The apparatus for rendering the video image as in claim 79 further comprising two or more vectors that generate outer loop intermediate values for a polynomial of the evaluated polynomials.

82. The apparatus for rendering the video image as in claim 79 wherein incrementally evaluated polynomials further comprise a non-additive combination of the evaluated polynomials within the loop processing area.

83. The apparatus for rendering the video image as in claim 62 further comprising a first micro-operation sequence that evaluates a first polynomial and a second micro-operation sequence that evaluates a second polynomial.

84. The apparatus for rendering the video image as in claim 62 further comprising a state memory that simultaneously stores intermediate values of a plurality of polynomials.

85. The apparatus for rendering the video image as in claim 62 wherein the polynomial processor further comprises a plurality of pipelined polynomial processors that simultaneously evaluate a plurality of polynomials.

86. A method for rendering a video image to a destination image space from a plurality of source image spaces, such method comprising the steps of:
generating a set of loop intermediate values from one or more polynomials;
incrementally evaluating polynomials within a parallelogram-shaped loop processing area of a source or a destination image space only within a bounding box that surrounds the loop processing area, said incremental evaluation occurring along an inner and an outer processing loop based upon the generated set of loop intermediate values; and
rendering a destination image space based upon the evaluated polynomials from the inner and outer loops.
